(19) United States
(12) Patent Application Publication
(10) Pub. No.: US 2025/0116376 A1
(43) Pub. Date: Apr. 10, 2025

(54) SYSTEMS, METHODS, AND APPARATUS FOR A TANK INSPECTION ROBOT AND TETHER MANAGEMENT SYSTEM

(71) Applicant: Square Robot, Inc., Marlborough, MA (US)

(72) Inventors: Jerome VAGANAY, Westport, MA (US); Ross JARVIS, Quincy, MA (US)

(73) Assignee: Square Robot, Inc., Marlborough, MA (US)

(21) Appl. No.: 18/906,009

(22) Filed: Oct. 3, 2024

Related U.S. Application Data
(60) Provisional application No. 63/587,817, filed on Oct. 4, 2023.

(51) Int. Cl. F17C 13/02; B65H 63/04; B65H 63/08

(52) U.S. Cl. CPC F17C 13/02; B65H 63/04; B65H 63/08; B63B 2205/04; B65H 2701/34

(57) ABSTRACT

Systems, methods and apparatus for a tank inspection vehicle and a tether management system (TMS) are disclosed. The tank inspection vehicle is connected to the TMS via a negatively buoyant tether. The TMS is also connected to a power source external to a tank via a power and communications cable. The TMS selectively connects the vehicle to the power source via the tether and the power and communications cable. The TMS may include a frame, a float, a reel, a reel mechanism, a float switch, one or more sensors, and a control unit having one or more processors communicable with one or more memories. The TMS is configured to reel or unreel the tether in response to the movement of the vehicle and provide power to the vehicle when the TMS, vehicle, and the components thereof are submerged in a flammable fluid.

### CROSS-REFERENCE TO RELATED APPLICATION

The present application claims priority to and the benefit of U.S. Provisional Patent Application No. 63/587,817, filed Oct. 4, 2023, the entire disclosure of which is hereby incorporated by reference herein.

### BACKGROUND

Tanks can store fluids or liquids, including flammable fluids such as petroleum products. The fluid can corrode portions of the tank that come into contact with the fluid. External surfaces of the tank can corrode due to water or other fluids under the floor of the tank, or water that leaked into the tank through, for example, a roof seal and sank below the hydrocarbon fluid due to its higher density. Corrosive elements in the hydrocarbon fluid can also contribute to corrosion. This corrosion can eventually cause the tank to leak. However, it can be challenging to determine the integrity of the tank to prevent leaks.

Due to the hazards, time, and resource intensity of out-of-service inspection, in-service inspection (e.g., via a tank inspection vehicle) is generally advantageous. However, in-service inspection also presents technical challenges. Battery-powered inspections vehicles-which must be moved in and out of a tank multiple times for recharging-increase the time spent operating equipment on the tank roof and the risk of equipment and personnel falling and being harmed.

### SUMMARY

The systems, apparatuses, and methods disclosed herein address technical challenges associated with in-service tank inspection. For example, the systems, methods, and apparatus of an externally powered tank inspection robot and tether management system improve the speed at which in-service inspections may be performed, reduce hazards associated with the management of in-service inspection equipment, and reduce the cost of in-service inspections, among other benefits. These benefits are achieved, for example, by the ability of the tank inspection robot to enter a tank via a roof manway (in some instances without requiring the use of hoists, davits, etc. due to the light weight of the robot) and submerge in the tank product before receiving power. Additionally, the tank inspection robot and tether management system allow for sealing of the roof manway to prevent leakage of flammable vapors while the inspection robot carries out operations. Further, the tank inspection robot and tether management system may deactivate power, allow unsealing of the roof manway, and be retrieved from the tank without draining the product from the tank.

In some aspects, a system for a tank inspection vehicle is disclosed. The system is configured to operate in a tank containing a flammable fluid. The system comprises a tether configured to provide power to the tank inspection vehicle, a cable configured to provide power across a vapor layer of the flammable fluid in the tank, and a tether management system. The tether management system may include a reel configured to control a length of the tether coupled thereto, a control unit configured to operate the reel such that a target length of the tether extends between the tether management system and the tank inspection vehicle where the target length is based on a position of the tank inspection vehicle relative to the tether management system when deployed in the tank, and a float switch electrically coupling the tether to the cable by closing a circuit therebetween when a buoyant force on the float switch is greater than a force threshold and configured to electrically disconnect the tether from the cable by opening the circuit when the buoyant force on the float switch is less than the force threshold.

In other aspects, a system for inspecting a tank containing a flammable fluid is disclosed. The system comprises a power source disposed outside the tank, a float configured coupled to a tether management system such that a first portion of the tether management system is configured to remain above a surface of the flammable fluid and a second portion of the tether management system is configured to remain below the surface of the flammable fluid when deployed inside the flammable fluid of the tank, a cover coupled to the tank and having an adjustable cable passageway extending therethrough, and a cable coupled to the power source, extending through the adjustable cable passageway, and coupled to a switch of a tether management system. The cable may be secured in the adjustable cable passageway such that the tether management system remains positioned substantially beneath a roof manway of the tank at a first position. A tether is coupled to the switch of the tether management system and to a tank inspection vehicle, the tether configured to provide power to the tank inspection vehicle when the tether is fully submerged in the flammable fluid. A control unit is configured to operate a reel to control a target length of the tether extending between the tether management system and the tank inspection vehicle, the target length configured to increase or decrease corresponding to a change in a distance between the tank inspection vehicle and the first position of the tether management system.

A method for managing a tether of a tank inspection vehicle, the method comprising: submerging the tank inspection vehicle in a flammable fluid of a tank; at least partially submerging a tether management system in the flammable fluid of the tank, the tether management system comprising: a cable configured to provide power across a vapor layer of the flammable fluid in the tank; the tether coupling the tank inspection vehicle to a reel of the tether management system, the tether configured to provide power and communications signals to the tank inspection vehicle; a switch configured to electrically couple the tether to the cable; a control unit configured to operate the reel to control a target length of the tether extending between the tether management system and the tank inspection vehicle; after an entirety of the tether is submerged beneath the flammable fluid, actuating the switch to provide power and communications signals to the tank inspection vehicle via the tether; during an operation of the tank inspection vehicle, determining, by the control unit, the target length based on a position of the tether management system within the tank and a position of the vehicle such that the target length does not exceed a maximum length based on a size of the tank; and operating the reel by the control unit such that the target length extends between the tether management system and the tank inspection vehicle.

This disclosure is further directed to systems, methods, and apparatus for a tank inspection robot and submerged tether management system. In preferred embodiments, the tank inspection robot is externally powered and is configured to enter a tank via a roof manway along with a tether management system to enable the robot to receive power and communications from outside the tank. In this way, the tank inspection robot and tether management system may be sufficiently small/lightweight to pass through a roof manway, cross the vapor layer in an unpowered mode, and submerge into the fluid of the tank. Once submerged, the tank inspection robot may remotely, autonomously, or semi-autonomously operate (e.g., inspect the tank) while the tether management system prevents non-HAZLOC-rated equipment from receiving power in the vapor layer. The tether management system may also remotely or autonomously control the length of the tether linking the tether management system to the robot such that the robot may navigate without becoming encumbered by the tether.

In various embodiments, the tether management system (TMS) may at least partially float atop the tank product or may be fully submerged in the tank product. Non-HAZLOC rated portions of the TMS are isolated from the vapor layer and the TMS is configured to provide power and communications to the robot via a negatively buoyant tether when submerged at a sufficient depth. The TMS may also be configured to stop the transmission of power in anticipation of the TMS and/or tank inspection robot traversing the vapor layer.

According to some embodiments, the systems, methods, and apparatus disclosed herein allow for launching and recovering of an autonomous, semi-autonomous, or remote tank inspection vehicle via a roof manway of an aboveground storage tank. By utilizing a TMS to provide power and communications to the robot from outside the tank, the tank inspection robot may be smaller/lighter than inspection robots that are powered by a heavy internal battery. For example, the TMS may enable the tank inspection robot to operate without a battery, battery compartment, fuel cell, etc. Further, communications, processing, and data management equipment for the inspection process may be located outside the tank, further decreasing the weight and size of the inspection robot. With a smaller/lighter profile and a TMS that prevents the robot from entangling or being unencumbered by the tether, the systems, method, and apparatus disclosed herein enable faster, more efficient, and less resource intensive tank inspections. Further, by operating the vehicle via an external power source, inspections may occur without pauses to remove the vehicle (e.g., to recharge a battery).

Further, equipment and tools used for in-service tank inspection may be deployed into the tank from a manway located on the roof of the tank. However, the roof of the tank has a weight limitation based on construction, material, and design of the roof. Moreover, navigating a tank inspection vehicle through the roof manway of the tank can be complex and entails a hazardous classification of class 1, division 1 (“C1D1”) as explosive or flammable gases, vapors, or liquids can exist under regular operating conditions. The tank inspection vehicle and TMS disclosed herein may be lifted onto the roof of the tank (either manually or via lift equipment) and may be deployed into the tank in a deactivated state. The roof manway may be sealed by a cover interoperable with the TMS. The cover may rigidly surround a power cable and prevent vapors from escaping while the inspection robot and TMS are deployed.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a cross-sectional view of a tank containing a flammable fluid;

FIG. 2 is a block diagram of an embodiment of an externally powered tank inspection robot and a floating TMS in a fixed roof tank;

FIG. 3 is a block diagram of an embodiment of an externally powered tank inspection robot and a sinking TMS in a fixed roof tank;

FIG. 4 is a block diagram of an embodiment of an externally powered tank inspection robot and a floating TMS in a floating roof tank;

FIG. 5 is a block diagram of an embodiment of an externally powered tank inspection robot and a sinking TMS in a floating roof tank;

FIG. 6A is a schematic block diagram illustrating an embodiment of a TMS;

FIG. 6B is a schematic diagram illustrating an embodiment of a TMS;

FIG. 7 is an illustration of one embodiment of a tank inspection robot interoperable with a vehicle and tether management system;

FIG. 8 is an illustration of one embodiment of a data processing system interoperable with a tank inspection system, a vehicle, and a tether management system.

### DETAILED DESCRIPTION

Following below are more detailed descriptions of various concepts related to, and implementations of, systems, methods and apparatus for a tank inspection robot and submerged tether management system. For example, the tank inspection vehicle may be selectively connected to an external power source via the tether management system. The vehicle and tether management system may be deployed in a power-off state such that a non-HAZLOC certified tether between the vehicle and the tether management system receives no power as it passes through a vapor layer of the tank. In some embodiments, the vehicle may submerge while the tether management system may at least partially float at the surface of the tank product. The tether management system may ensure that non-HAZLOC certified components do not receive power unless they are fully submerged and removed for the vapor layer. In other embodiments, the tether management system may sink to the floor of the tank, likewise ensuring that power is not provided while non-HAZLOC certified components are exposed to the vapor layer.

Specifically, and beneficially, the subject matter disclosed herein may simplify the installation, launch, and recovery of a tank inspection vehicle, extend the duration of tank inspections, reduce hazardous operator time on a tank roof, and reduce environmental impact by limiting the leakage of vapors from a tank. For example, C1D1 cable often used in conjunction with tank inspection vehicles is rated for providing power and communications signals across vapor layers, but poses issues because it is too heavy/inflexible to be used as manageable/reel-able tether (e.g., given its size, diameter, and the like). However, manageable tether (e.g., that can be wound and un-wound from a reel) such as cable having a smaller diameter, reduced weight, and increased flexibility is not rated to provide power and communications signals through the vapor layer. Accordingly, non-HAZLOC certified tethers are generally not utilized in applications with tanks containing flammable fluid or tank inspection vehicles because power cannot go through tether while any portion thereof or electronic components attached thereto are in the vapor layer. However, the instant application discloses systems, methods, and devices developed to avoid this problem and that incorporate a manageable non-HAZLOC certified tether while ensuring no power or communications signals flow through the tether while the tether is in or near the vapor layer. In some embodiments, the tether and systems here in are configured to ensure no power flows through tether while in operation, for example, by utilizing a specific combination of HAZLOC certified C1D1 cable, a float switch configured to prevent the flow of power unless all non-HAZLOC certified components are submerged beneath the vapor layer, and a flexible/reel-able tether configured provide power to the tank inspection robot.

The system can include a tank inspection vehicle and a tether management system including a frame, float, reel, motor, float switch, sensors, and/or a control unit with one or more processors and memory. The tether management system may selectively provide power and communications to the vehicle via a negatively buoyant and flexible tether. Additionally, the tether management system may reel in or extend out cable in response to receiving a location of the vehicle in the tank. Further, the tether management system may selectively connect the vehicle to a power source external to the tank via a HAZLOC certified (e.g., C1D1) power and communications cable.

The system can include a manway located at a top of the tank and a cover to seal-ably receive the C1D1 cable such that flammable vapors cannot escape the tank while the tether management system and vehicle are deployed in the tank. The manway may also be referred to as, and used interchangeably with other descriptive terms, top manway, roof manway, roof entry. The systems and apparatus disclosed may be installed and operated without draining the fluid from the tank.

Additionally, externally powering the tank inspection vehicle may reduce the profile or weight of the tank inspection vehicle such that additional equipment is not required to hoist the vehicle and/or the TMS to the roof of the tank. Further, deploying a TMS inside the tank removes the need for roof-top tether management and reduces the time personnel must spend on the roof of the tank. In turn, the technology disclosed herein may lower the likelihood of the equipment or personnel falling off a topside of the tank and getting injured or damaged. Additionally, deploying an externally powered tank inspection robot and TMS may require less equipment and weight on the tank roof, so the systems and apparatus disclosed herein may provide a decreased risk of weakening the structural integrity of the top side of the tank, which could result in a potential collapse of the topside. Finally, the TMS may allow the top manway to be sealed during operation of the TMS and tank inspection robot, thereby preventing flammable vapors or Volatile Organic Compounds (VOC) from exiting at the topside.

### Exemplary Tank and Components for a Submerged Tether Management System (TMS)

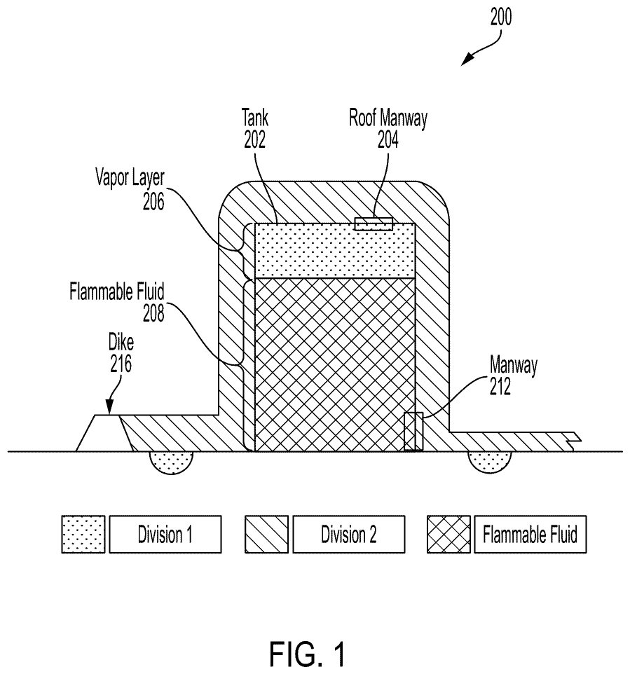

Referring to FIG. 1, example illustrations of a tank containing a flammable fluid, in accordance with some implementations, are shown. FIG. 1 provides a side cross-sectional view of the tank 202. In brief overview, as shown in FIG. 1, tank 202 includes a roof manway 204, a side manway 212, and a dike 216. The tank 202 contains flammable fluid 208. A vapor layer 206 fills the space between the top of the flammable fluid 208 and the roof of the tank 202. In some implementations, the tank 202 can include a winch (not shown in FIG. 1). The tank 202 can be constructed using one or more materials including metal (e.g., steel, aluminum, alloys, etc.), glass, or plastic (e.g., high-density polyethylene).

Still referring to FIG. 1, and in more detail, the roof manway 204 of the tank can be constructed using materials similar to the tank 202. The roof manway 204 can be configured with a locking mechanism to prevent opening of the roof manway 204 prior to a completion of the tank inspection process 134. The roof manway 204 can be constructed to seal or keep the vapor layer 206 within the tank 202.

Within the tank 202, and above the surface of the flammable fluid 208, a vapor layer 206 typically exists and is a gaseous state of the flammable fluid 208. The vapor layer 206 may be located at various locations in the tank based on the height of the flammable fluid 208. For example, in nearly a full tank 202, the vapor layer 206 may be relatively thin and easier to traverse when compared to a vapor layer 206 in a half-full tank 202, which may occupy more volume and may be lengthier to traverse. The vapor layer 206 typically is flammable.

As shown in FIG. 1, the tank 202 can include a manway 212 located at the side of the tank 202. The manway 212 may be used for accessing the interior of the tank 202 for other purposes or for installing other equipment to the tank 202. The manway 212 may be included as part of the construction of the tank 202. The manway 212 may include a lid. The lid may be similar to the roof manway 204 on the roof of the tank 202. The lid of the manway may be removed similarly to removing the roof manway 204 on the roof of the tank 202. The manway 212 may be located anywhere on the side of the tank. The manway 212 may be elevated from the ground (e.g., grade, tank floor, etc.), such as 12 inches, 14 inches, or 16 inches from the ground. The manway 212 may not be elevated from the ground (e.g., the bottom edge of the manway sits on the ground).

The manway 212 of the tank 202 may protrude from the tank shell. The tank shell can refer to the exterior surface of the tank 202. The manway 212 may protrude from the tank shell as to couple with a lid. For example, bolts may be used for coupling a lid with the manway 212. The protrusion of the manway 212 can prevent the bolts used from entering the interior of the tank 202. In some implementations, the manway 212 may not protrude from the tank shell. For example, the manway 212 may be flushed or leveled to the tank shell or the exterior surface of the tank 202. The manway 212 can include a door or a gate to form an opening in the side of the tank 202. The door or the gate of the manway 212 can be opened via pulling, sliding, or lifting method.

The system 200 can include a dike 216 located around the tank 202 to contain potential product leaks from the tank 202. The dike 216 can be constructed with metal, cement, granite, etc. In some cases, the system 200 may not include the dike 216.

Still referring to FIG. 1, areas around the tank 202 may be classified with one or more hazardous classifications. The hazardous classification can include at least a class 1, division 1 (“C1D1”) and a class 1, division 2 (“C1D2”). The C1D1 hazardous classification can refer to an area where explosive or flammable gases, vapors, or liquids can exist under regular operating conditions. The C1D2 hazardous classification can refer to an area where explosive or flammable gases, vapors, or liquids are not likely to exist under regular operating conditions. For example, the area above the flammable fluid 208 can include a hazardous classification of C1D1. This classification is due to the fumes and vapors rising up above the flammable fluid 208 and vapor layer 206 of the tank 202. The roof of the tank 202 may be classified as C1D1 in some instances. Subsequently after opening the roof manway 204 on the roof of the tank 202, the area on the roof of the tank 202 can be classified under C1D1 hazardous classification as flammable vapors leave the tank via the roof manway 204. In other instances, the roof of the tank 202 may be classified as C1D2, for example, when the roof manway 204 is sealed, or when the cover 424 is installed on the roof manway 204 and prevents the escape of flammable vapors. In a further example, the vicinity around the tank 202 can include a C1D2 hazardous classification, as with the manway 212 location.

### Exemplary Deployment Configurations for a Submerged Tether Management System (TMS)

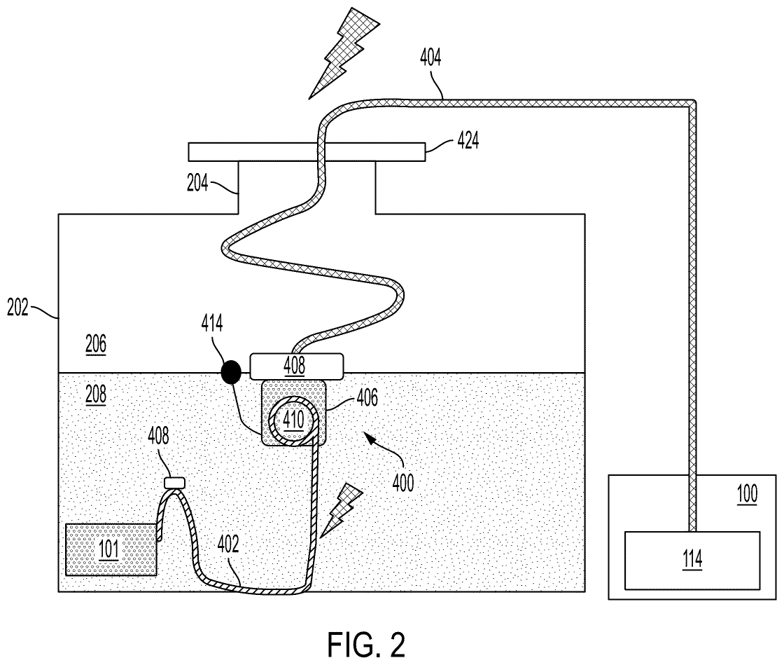

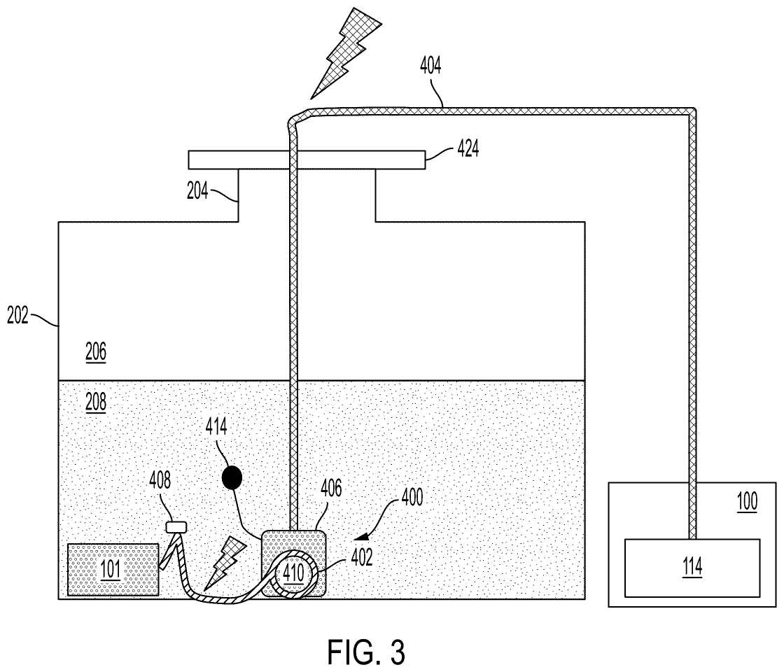

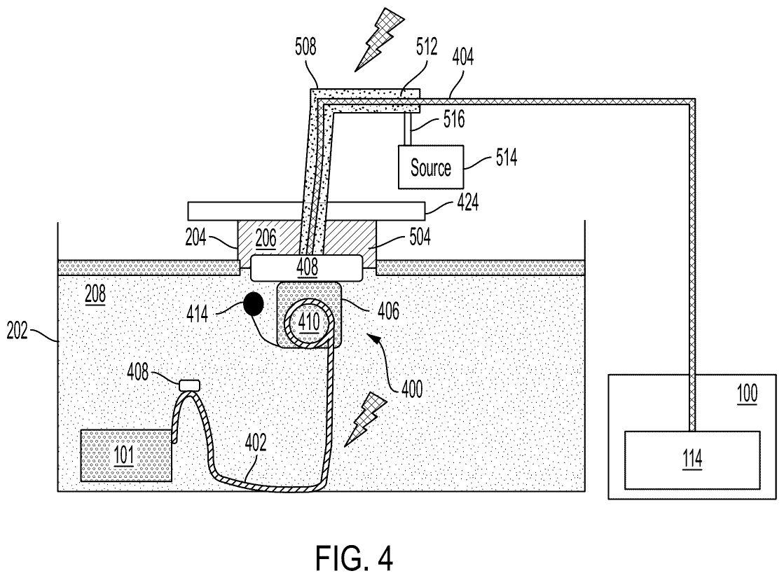

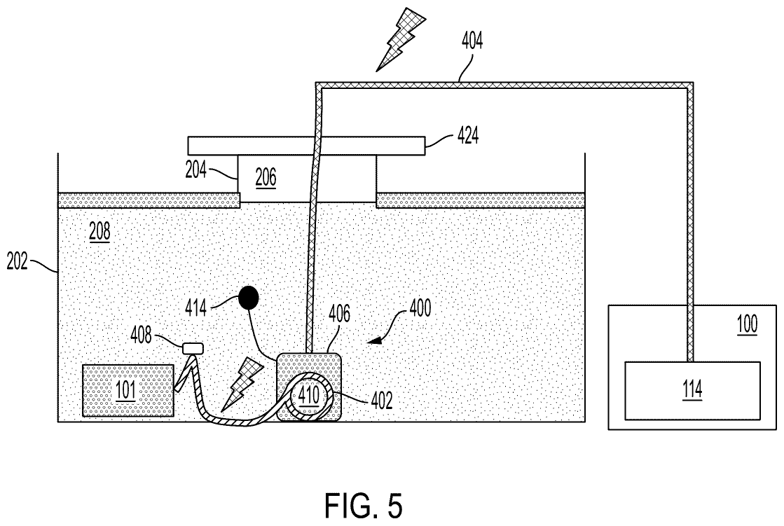

The TMS 400, tank inspection system 100, and tank inspection vehicle 101 may be deployed in a variety of tanks, industrial fluids, settings and in a variety of configurations. In some configurations, additional components and features may be included on the TMS 400 as discussed below. These additional components and features may include vapor-tight covers 424, one or more floats 408 coupled to the TMS 400 and/or one or more float switches 414, the injection of fire suppressant foam atop the flammable fluid 208, the use of a cable enclosure filled with an inert gas, and the like. For example, the TMS 400 and tank inspection robot 101 may be deployed in a fixed roof tank 202 with a floating TMS 400 (FIG. 2), a fixed roof tank 202 with a sinking TMS 400 (FIG. 3), a floating roof tank 202 with a floating TMS 400 (FIG. 4), a floating roof tank 202 with a sinking TMS 400 (FIG. 5), and in other configurations.

In general, and as discussed in more detail below, methods of deployment of a tank inspection vehicle 101 and a TMS 400 may include the following steps. Initially, external power from the power source 114 may be powered off so that the tank inspection vehicle 101, the tether 402, and the TMS 400 are not receiving power and may safely traverse the vapor layer 206. The tank inspection vehicle 101 and the TMS 400 may be lifted or deployed to the roof of a tank 202. In some embodiments, the vehicle 101 and TMS 400 may be manually lifted, while in other embodiments, a hoist, davit, or crane may assist in lifting the TMS 400 and vehicle 101 to the roof. A roof manway 204 may then be opened, and the powered-off tank inspection vehicle 101 and TMS 400 may be lowered into the tank 202. In some embodiments, the roof manway 204 may be approximately 16″, 18″, 20″, or 24″ in diameter. Accordingly, the tank inspection vehicle 101 and TMS 400 may be sized to each be inserted through a roof manway 204 approximately between 18″-24″ in diameter. The tank inspection vehicle 101 may be lowered beneath the surface of the tank product. Similarly, the negatively buoyant tether 402 may sink beneath the surface of the tank product. In some embodiments, the TMS 400 may float near, just below, or partially above the surface of the tank product via the float 408. For example, the float 408 may be configured such that the TMS 400 is submerged while only a portion of the float 408 remains above the surface of the tank product. In other embodiments, the TMS 400 may be configured to submerge and settle at the floor of the tank 202 (e.g., when no float 408 is equipped to the TMS 400). An operator may lower the vehicle 101 and the TMS 400 down via the roof manway 204 at an unpowered state such that power is not activated or cannot flow through the tether 402 until the tether 402 is submerged beneath the flammable fluid 208. Once the TMS 400 and the tank inspection robot 101 are deployed, the roof manway 204 may be sealed by a cover 424.

The cover 424 may be configured to tightly seal around or against a flange of the roof manway 204. The cover 424 may also include a sealable cable passageway (e.g., a configurable hole, gap, slot, or the like) that tightly seals around the C1D1 cable 404. The fit between the power and communications cable 404 and the cover 424 may be sufficiently snug that the power and communications cable 404 does not move relative to the cover 424. For example, the seal between the cover 424 and the power and communications cable 404 may be vapor-tight and not allow emissions to escape from the roof manway 204 and may not allow for the power and communications cable 404 to slide further into or slide out of the tank 202 once the cover 424 is affixed to the roof manway 204.

The cover 424 may include a sealable cable passageway such as adjustable hole, gap, slot, clamp, or the like that receives the power and communications cable 404 such that a desired length of the power and communications cable 404 can be inserted through the sealable cable passageway in the cover 424 and be fixed in place to form a vapor-tight seal around the power and communications cable 404. When the appropriate length of power and communications cable 404 is extended through the sealable cable passageway in the cover 424 such that the TMS 400 will receive enough slack or a sufficient length of C1D1 cable 404 to reach the tank product, the sealable cable passageway (e.g., the adjustable hole, gap, slot, or the like) may be configured to tighten/seal around the C1D1 cable 404 such that the C1D1 cable 404 may no longer slide relative to the cover 424 and emissions are prevented from escaping at the interface between the C1D1 cable 404 and the cover 424.

Once the tank inspection vehicle 101 and the TMS 400 are deployed, the external power source 114 may be powered on. If the TMS 400, the tether 402, and the vehicle 101 are sufficiently submerged (at which point the float switch 414 allows power from the power source 114 to be applied to the C1D1 cable 404) power may be supplied via the TMS 400 to the tank inspection vehicle 101. The TMS 400 and/or the tank inspection vehicle 101 may then operate remotely, semi-autonomously, or autonomously within and inspect the tank 202. For example, a user may receive sensor information at a user interface (e.g., an LCD screen, a map, a computer interface) and issue commands to the tank inspection vehicle 101 and/or the TMS 400 to navigate, release more tether, pull in tether, and the like. Or this process of controlling the inspection vehicle 101 and the TMS 400 may be partially or fully automated (e.g., carried out with limited or no human oversight by programming, logic, or commands stored on one or more control units 104, 418 discussed herein). Once the tank inspection process is complete, external power from the power source 114 may be shut off. The cover 424 may be unsealed from the roof manway 204, and an operator may retrieve the TMS 400 and the tank inspection robot 101.

Turning to FIG. 2, a tank inspection vehicle 101 and floating TMS 400 are shown deployed in a fixed roof tank 202. The tank inspection vehicle 101 and the floating TMS 400 are connected to a system for tank inspection 100 via the C1D1 cable 404. The C1D1 cable 404 is HAZLOC certified and may carry power and communications safely across the vapor layer 206. However, the rigidity and size of the C1D1 cable 404 limit its functionality as a nimble tether (e.g., the tether 402) to reel/unreel responsive to the movements of the tank inspection robot 101. Accordingly, the C1D1 cable 404 may be of sufficient length to connect the external power source 114 to the TMS 400. In the floating TMS 400—fixed roof tank 202 embodiment shown in FIG. 2, a first length of C1D1 cable 404 extends from the external power source 114 to the outward facing side of the cover 424 (e.g., from the power source 114 to the sealable cable passageway in the cover 424). A second length of C1D1 cable 404 extends from inward facing side of the cover 424 (e.g., from the sealable cable passageway) and connects to the TMS 400. For a floating-TMS 400 in a fixed roof tank 202, it is desirable that the second length of C1D1 cable 404 has sufficient slack (e.g., excess cable length such that the TMS 400 avoids hanging in the air should the tank product lower, excess cable to allow the TMS 400 to float and navigate along the surface of the tank product). For example, the slack in the C1D1 cable is shown as an “S”-shaped curve of cable 404 in FIG. 2. Should flammable fluid 208 be pumped out the tank 202 and the surface level of the flammable fluid 208 drop, the slack allows the TMS 400 to follow the surface downward, keeping the tether 402 and other components submerged and away from the vapor layer 206. In other embodiments, the slack in the C1D1 cable 404 may be removed once the TMS 400 is positioned in the flammable fluid such that the TMS 400 is configured to remain substantially below the manway 204 and at a surface of the flammable fluid. A position of the TMS 400 may then be identified based on the length of C1D1 cable 404 between the TMS 400 and the roof manway 204 and/or the cover 424. If TMS 400 were to start to hang from the C1D1 cable 404 due to lack of slack caused by fluid draining from the tank 202, the float switch 414 may be configured to shut off power from the power source 114 and prevent power from flowing into the C1D1 cable 404 before any electrical components and/or the tether 402 enter the vapor layer and/or in response to the tether 402 or another component reaching a minimum distance away from the vapor layer.

As shown in FIG. 2, the inert float 408 may be partially above the surface of the tank product while the frame 406, reel 410, negatively buoyant tether 402, and/or other components of the TMS 400 remain submerged beneath the surface. The float switch 414 is configured to connect the C1D1 cable 404 to the power source 114 (using dedicated wires in C1D1 cable 404) such that power may flow from the power source 114, through the C1D1 cable 404 to the tank inspection robot 101 via the tether 402 when the TMS 400 and the components thereof are submerged a sufficient distance from the vapor layer 206.

As the tank inspection vehicle 101 navigates in the tank 202, the floating TMS 400 in a fixed roof tank 202 may wander, on the surface of product 208, away from the roof manway if the product level changes due to fluid being pumped in and out of the tank. Unless very large amounts of fluid are moved, the roof manway location remains a good approximation of the location of TMS 400 for the purpose of calculating the tether 402 length that should be paid out to the inspection vehicle 101. In case of large product height variations, the tight seal around the C1D1 cable 404 in cover 424 could be loosened and the length of the C1D1 cable 404 between the cover 424 and the TMS 400 manually adjusted to bring the TMS 400 back under the roof manway. The position of the roof manway 204, the TMS 400 (approximated as the position of the roof manway 204), and the tank inspection robot 101 may then be used to determine an appropriate length of tether 402 to pay out/reel in to allow the tank inspection robot 101 to inspect the tank unhindered by the tether 402. Additionally, as shown in FIG. 3, one or more floats 408 may be affixed to the tether 402 near the tank inspection robot 101 (e.g., 3 feet away, 5 feet away, 10 feet away, etc.) such that the negatively buoyant tether 402 is guided upward in the tank product and out of the way of the components of the tank inspection vehicle 101.

Additionally, the control unit 418 of the TMS 400 may be configured to track or determine a length of tether 402 to pay out/real in. For example, the memory 420 of the control unit may track a degree of rotation of the reel 410 relative to a starting reel position and correlate the rotation of the reel 410 to a length of tether 402 paid out in the tank 202. The length of tether 402 may be reported to an operator or may be compared to a distance between the tank inspection robot 101 and the TMS 400. In this way, the TMS 400 and/or the control unit 418 may determine a distance between the tank inspection vehicle 101 and the TMS 400 and release a target length of tether 402 to allow the tank inspection robot 101 to navigate in the tank 202. The TMS 400 may pay out or reel in tether 402 based on the position of the vehicle 101 in relation to the roof manway 204. In other embodiments, the location of the vehicle 101 and/or a distance of the vehicle 101 from the roof manway 204 and/or the TMS 400 may be reported to an operator (e.g., displayed via a user interface). The operator may control the TMS 400 remotely to reel in or pay out a designated length of tether 402.

Turning to FIG. 3, a tank inspection vehicle 101 and sinking TMS 400 are shown deployed in a fixed roof tank 202. The tank inspection vehicle 101 and the sinking TMS 400 are connected similarly connected to a system for tank inspection 100 via the C1D1 cable 404. In the fixed roof tank 202 and sinking TMS 400 embodiment, however, the location of the TMS 400 in the tank 202 remains fixed. For example, the TMS 400 may sink to the bottom of the tank 202 directly beneath the roof manway 204. Accordingly, a designated length of C1D1 cable 404 may be utilized and an excess of slack in the C1D1 cable may not be necessary, unlike in the fixed roof floating TMS 400 embodiments. The C1D1 cable 404 may be of sufficient length to connect the external power source 114 to the TMS 400 and of sufficient length from the inside surface of the cover 424 to lower the TMS 400 to the floor of the respective tank 202. For the sinking-TMS 400 in a fixed roof tank 202, it may be desirable that the second length of C1D1 cable 404 has limited slack (e.g., the TMS 400 reaches the floor of the tank 202 with little 3 feet or less of excess/loose C1D1 cable). Providing limited slack lessens the likelihood that the TMS 400 drifts off target when lowered into the flammable fluid 208 and remains directly beneath or nearly directly beneath the roof manway 204 and resting on the floor of the tank 202. In this way, the horizontal location of the sinking TMS 400 may be approximated by the horizontal position the roof manway 204. Accordingly, the length of tether 402 released or reeled in may be related to the horizontal position of the tank inspection vehicle 101 in the tank and the horizontal position of the roof manway 204. Additionally, in this embodiment, the sinking TMS 400 may be configured to rest on the floor and the tank 202 and thus be insensitive to product level changes (e.g., will not shift horizontally away from under the roof manway 204, in response to the surface of the fluid rising or falling).

As shown in FIG. 3, the components of the TMS 400 (e.g., the frame 406, reel 410, negatively buoyant tether 402, etc.) remain submerged beneath the surface while the tank inspection vehicle 101 navigates the tank 202. The float switch 414 is configured to connect the C1D1 cable 404 to the power source 114 such that power may flow from the C1D1 cable 404 to the tank inspection robot 101 via the tether 402 when the TMS 400 and the components thereof are submerged in the fluid 208. In some examples, the float switch 414 may be configured to prevent power from passing to the tether 402 when the tether is 1 meter, 0.5 meters, or 300 mm from the surface. In other examples, the float switch 414 may prevent the tether 402 from receiving power unless the tether 402 is 3 meters or more beneath the surface. As illustrated in FIG. 4, if the tank product begins to drain from the tank 202 and the surface of the flammable fluid 208 lowers nearer to the TMS 400, the float switch 414 may trigger (e.g., float atop the surface and lose sufficient height to activate its internal switch) and disconnect the C1D1 cable 404 from the power source 114. In this way, the sinking TMS 400 may likewise prevent power from reaching the vehicle 101, the TMS 400, and/or the tether 402 if components thereof become sufficiently close to the vapor layer 206.

As the tank inspection vehicle 101 navigates in the tank 202, one or more floats 408 may be affixed to the tether 402 near the tank inspection robot 101 (e.g., 3 feet away, 5 feet away, 10 feet away, etc.) such that the negatively buoyant tether 402 is guided upward in the tank product and out of the way of the components of the tank inspection vehicle 101. Additionally, the control unit 418 of the sinking TMS 400 may be configured to track or determine a length of tether 402 to pay out/real in in a manner similar to that of the floating TMS 400. For example, the memory 420 of the control unit may track a degree of rotation of the reel 410 relative to a starting reel position and correlate the rotation of the reel 410 to a length of tether 402 paid out in the tank 202. The length of tether 402 may be reported to an operator or may be compared to a distance between the tank inspection robot 101 and the TMS 400.

As shown in FIGS. 4 and 5, both the floating TMS 400 and the sinking TMS 400, respectively, may also be deployed in floating roof tanks 202. For the floating TMS 400 and the floating roof tank 202, the slack required in the C1D1 cable 404 between the cover 424 and the TMS 400 need not be as lengthy as that required in the fixed-roof tank 202 floating TMS 400 embodiments because the floating roof- and the roof manway 204 and cover 424—will follow the surface level of the tank product as the surface level rises and falls. For the floating roof and sinking TMS 400 embodiments, it may be particularly desirable to limit the slack in the C1D1 cable 404 and the cover 424. For example, should 5 feet of slack be present, and the fluid level drain by 10 feet, the excess length of C1D1 cable 404 may sink to the bottom/floor of the tank 202 and interfere with the operation of the tank inspection vehicle and/or the TMS 400.

As illustrated in FIG. 4, additional components and features may be included and/or operated in parallel with the TMS 400 in any of the configurations discussed herein. As shown and described with reference to the floating TMS 400 in a floating roof tank 202, the inside of the manway 206 may include flammable vapors and be classified as Zone 0. In some embodiments, the C1D1 cable may be utilized in conjunction with other hazard-mitigating features such as the use of a fire suppressant 504 (e.g., a fire suppressing foam), the use of a C1D1 cable cover 508, and/or the use of an inert gas 512 (e.g., nitrogen) to insulate/form a barrier between the C1D1 cable 404 and any Zone 0 regions in and/or around the tank 202.

For example, the floating roof tank 202 is illustrated with a fire suppressant 504 injected into the manway 424 such that the fire suppressant 504 (e.g., foam, non-combustible particles, inert gas, etc.) fills some or all of the volume of the tank 202 above the product surface. In some embodiments, the fire suppressant 504 may be inserted such that it fills the area above the flammable fluid 208 all the way to the top of the manway 424. In this way, the fire suppressant 504 may push and/or displace the flammable vapors out of the manway 424 to add a level of protection (e.g., by separating the flammable vapors from the cable 404).

Additionally, and as further illustrated in FIG. 4, the C1D1 cable 404 may be at least partially covered and/or enclosed in a cover 508 such as a hose, tube, piping, or other suitable vessel. In some embodiments, the cover 508 may extend from the float 408 to the manway 424 and in other embodiments the cover 508 may extend along substantially the entire length of the C1D1 cable 404. In FIG. 4, the cover 508 is shown partially extending along the length of the C1D1 cable 404. The cover 508 may be used alone and/or in conjunction with the fire suppressant 504, an inert gas 512, or the like. For example, the cover 508 may be fluidly coupled to a source 514 of an inert gas 508 and/or a fire suppressant 504 via a conduit 516. The source 514 may be opened such that the cover 508 is slightly over-pressured (e.g. raised to an internal pressure greater than atmospheric pressure). In this way, fire suppressant 504 and/or inert gas 512 (e.g., nitrogen, argon, etc.) may fill/occupy a space between the cover 508 and the C1D1 cable 404 to further separate/isolate the C1D1 cable 404 from any Zone 0 areas of the tank 202.

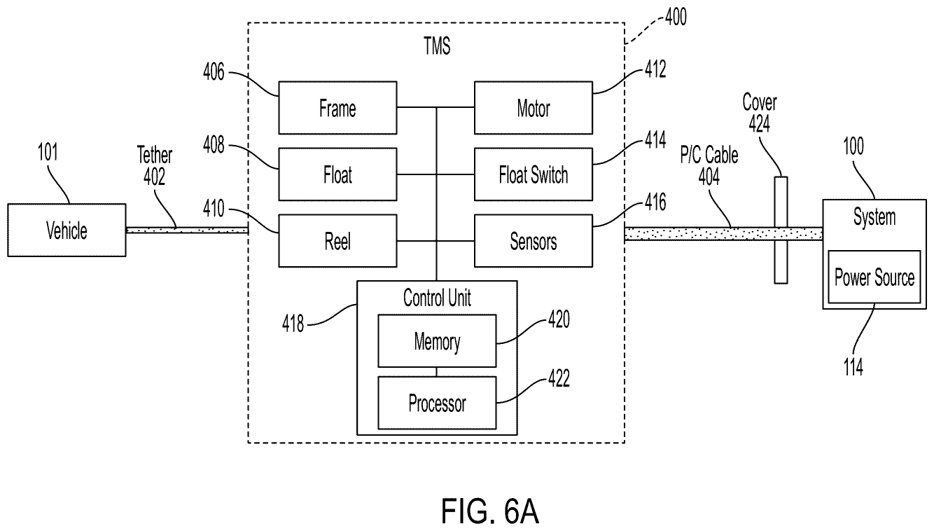

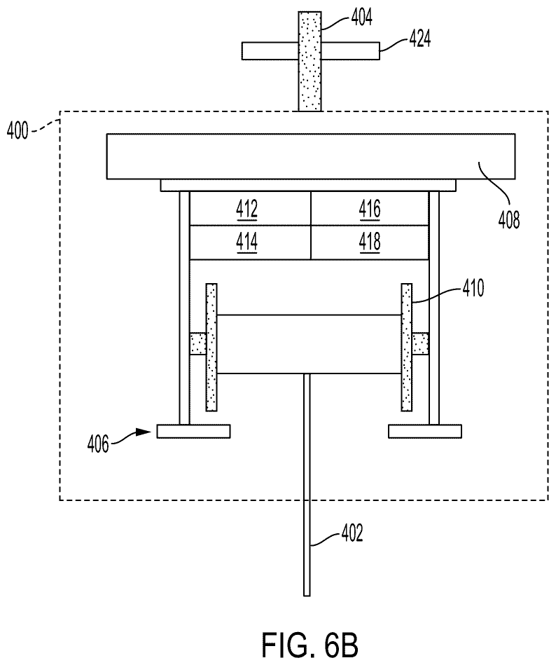

Turning to FIGS. 6A and 6B, a schematic block diagram and a schematic diagram illustrating exemplary TMS systems 400 are shown. The TMS 400 allows a tank inspection vehicle 101 to receive power and communications from outside the tank 202 and is configured to allow the tank inspection vehicle 101 to traverse the tank while receiving power by keeping non-HAZLOC certified cables or components below the vapor layer 206. Additionally, the TMS 400 is configured to deactivate power to non-HAZLOC certified components if such components approach the vapor layer 206.

As shown in FIG. 6A, the TMS 400 is connected to a tank inspection vehicle 101 via a tether 402. The TMS 400 is shown represented as dashed box 400. The TMS 400 may include multiple components such as a frame 406, a float 408, a reel 410, a motor 412, a float switch 414, and/or one or more sensors 416. The TMS 400 may also include a control unit 418 having one or more processors 422 configured to execute instructions stored on one or more memories 420. In some embodiments, the control unit 418 may be on board the TMS 400. In other embodiments, the control unit 418 may be located outside the tank 202, and in other embodiments, some components of the control unit 418 may be onboard while others are located offboard the TMS 400. In this way, the control unit 418 may operate and control the various functionalities of the TMS 400. For example, the control unit 418 may include instructions on the memory 420 indicating how far and when the TMS 400 should extend/unreel the tether 402. In some embodiments, the control unit 418 may receive power after an entirety of the tether 402 is submerged beneath the flammable fluid and/or after the actuation of a switch (e.g., a pressure switch, a float switch) to provide power and communications signals to the tank inspection vehicle via the tether. During an operation of the tank inspection vehicle, the control unit 418 may determine a target length of the tether 402 based on a position of the tether management system 400 within the tank 202 and a position of the vehicle such that the target length does not exceed a maximum length. The maximum length may be based on a size of the tank such as a tank depth, a tank diameter, or the like. In this way, the control unit 418 may prevent excess tether 402 from being reeled out and looping, coiling, or otherwise remaining free/loose inside the tank (e.g., unravelling 20 feet of tether even though the distance between the TMS 400 and the vehicle is 10 feet, and the tank is only 10 feet deep, etc.). In this way, the control unit 418 may operate the reel such that the target length extends between the tether management system and the tank inspection vehicle during operations of the vehicle.

In further embodiments, the control unit 418 and/or the power source 114 may be configured to identify a flow of current below a minimum flow (e.g., a flow of 0 current through the tether 402 and/or the cable 404) or a voltage difference between one end of the cable and another, etc. In response to identifying, for example zero current flowing through the cable 404, the control unit 418, the switch, and/or the power source 418 may be configured to prevent or disconnect the flow of power and/or communications signals to the TMS 400 and/or the vehicle.

Additionally, the TMS 400 is coupled to a system for tank inspection 100 and one or more components thereof located outside the tank 202 via a power and communications cable 404. The power and communications cable 404 may be a HAZLOC certified cable that can deliver power/ethernet/etc. across the vapor layer 206. For example, the power and communications cable 404 may include a C1D1 cable 404. The power and communications cable 404 may receive power from a power source 114 of the system 100. For example, the power source 114 may include a generator, a battery pack, a fuel cell, or another suitable power source 114. The power and communications cable 404 may also deliver ethernet or fiber optic communication lines to the TMS 400 and/or the tank inspection vehicle 101. As shown in FIG. 2A, power and communications connections travel from outside the tank 202 via the power and communications cable 404 to the TMS 400. The TMS 400 may then selectively transmit power and communications to the tank inspection vehicle 101 via the tether 402.

Turning to FIG. 6B, a second schematic block diagrams illustrating an exemplary TMS system 400 is shown. The TMS 400 may include a frame 406. The frame 406 may provide structural support and a foundation on which the other components of the TMS 400 are affixed. The frame 406 can be coated with non-flammable solution or an insulator. The non-flammable solution or insulator can be applied by spray coating, paint coating, attachment, or sheet cover. The non-flammable solution can include glass, mineral wool, gypsum, or magnesium. The insulator can include glass fiber, polyurethane, clay, or ethylene propylene diene terpolymer (“EPDM”) rubber. The frame 406 can be coated with linked or merged non-flammable solution and insulator to form a protected layer. The non-flammable solution and insulator can be selected based on the flammable fluid contained inside the tank. The frame 406 can be further coated with water resistance solution including durable water repellent (“DWR”). The one or more coatings of the frame 406 can be coated on the exterior of the frame 406 or embedded into the frame 406. The frame 406 may be configured to operate and remain sound in multiple environments, for example, below freezing temperatures or above boiling temperatures. The frame 406 may be configured operate under a submerged environment and may formed in a variety of manners such as in a spherical, cubic, cage-like, cylindrical, or other shape. The frame 406 can be constructed to prevent sparks or electrostatic discharge. The frame 406 can be constructed with one or more insulated layers to prevent sparks or electrostatic discharge. The one or more insulated layers can include a spark protection layer, which can be, for example, a rubber layer between one or more layer of steels, preventing accidental collision between the steel layers which can cause a spark. The frame 406 can include housing, brackets, bars, mounting structures, and other structural components to coupled together the components of the TMS 400.

The TMS 400 may also include a float 408. In some embodiments, the float 408 is configured to allow the TMS 400 to at least partially float atop a surface of the flammable fluid 208 while a portion of the TMS 400 remains below the surface of the flammable fluid 208. In other embodiments, the TMS 400 may not include a float 408 and may instead be configured to submerge completely beneath the surface of the flammable fluid 208 (e.g., be configured to rest or sit on the bottom of the tank 202). In some embodiments, the float 408 may be made of plastics (e.g., polyethylene), foams, composite materials, rubber (e.g., nitrile rubber or NBR), inflatable materials, or other suitable materials for floatation in a tank of flammable and/or corrosive fluids. The float 408 may be an inflatable device configured to receive air via a compressed flotation source, a blower, or the like. The flotation source or inflation device may be located on the TMS 400 or may be a separate component that selectively inflates and deflates the float 408. The floatation device may selectively inflate/deflate the float with a neutral or non-reactive substance such as nitrogen. The float 408 may be made of a buoyant material that are resistant to exposure to flammable fluids 208 and may be coated in an anti-static coating or similar protective coating as described above. The float 408 may be positioned on the TMS 400 such that a majority of the TMS 400 remains submerged while the float 408 remains atop the flammable fluid 208. In this way, the tether 402 and other components of the TMS 400 may be submerged beneath the flammable fluid 208 and remain separated from the vapor layer 206 while the float keeps the TMS 400 from sinking and colliding/sitting along the bottom of the tank 202.

The TMS 400 may also include a reel 410. The reel 410 may be configured to receive a length of tether 402 and selectively wind/unwind the length of tether 402 while the TMS 400 is in the tank 202. In this way, as the tank inspection vehicle 101 travels and inspects the tank 202, the reel 410 may release or spool in the tether 402 to provide enough slack/length of the tether 402 for the tank inspection vehicle 101 to navigate without releasing an excessive length of tether 402 which may become tangled or interrupt the tank inspection path of the tank inspection vehicle 101. In some embodiments, the reel may be spool shaped, helical, or other suitable shapes to reel in and reel out an appropriate length of tether 402. The reel 410 may include a level-wind mechanism designed to evenly distribute the tether 402 on and off the reel 410 as it is being retrieved/released. The level wind may include a moving guide or eye that moves back and forth horizontally across a spool of the reel. In this way, the reel 410 and level-wind may prevent the tether 402 from crossing over itself, which can lead to tangles and knots in the tether 402. In some embodiments, the reel 410 may be configured to receive 100 feet, 200 feet, 300 feet of tether 402. In other embodiments, the reel 410 may be configured to receive less than 100 feet of tether 402 or greater than 500 feet of tether 402.

The tether 402 may be a coated conductive cable and may include twisted pairs of ethernet cable and/or fiber optic cable for delivering power and/or communications from the TMS 400 to the vehicle 101. For example, the tether 402 may be a coated copper and ethernet cable that has a diameter significantly smaller than the diameter of the C1D1 cable 404. In this way, the tether 402 has a small diameter, more flexibility, and less rigidity than the C1D1 cable 404, making the tether 402 preferential for reeling out/in responsive to the movements of the tank inspection robot 101. Additionally, the negative buoyance of the tether 402 ensures the tether 402 will not float to the surface and become exposed to the vapor layer 206 after it is released from the reel 410. In preferred embodiments, the tether 402 utilized AC or a high DC voltage to allow for a smaller wire gauge and increased flexibility. Additionally, utilizing fiber optic cable instead of ethernet cable for communications allows for a narrower tether 402 with increased flexibility that requires less space to store/wind upon the reel 410.

The TMS 400 may also include a mechanism to wind and unwind the reel 410, such as a motor 412. In some embodiments, hydraulic systems, spring systems, pneumatic systems or the like may be used to wind and unwind the reel 410. The motor 412 or the like may be coupled directly to or within the reel 410 or may be coupled to another component of the TMS 400 and be configured to unwind/wind the reel via one or more connectors (e.g., gears). The motor 412 or the like may have one or more sensors 416 which tracks or measures the degree to which the reel is wound/unwound. Additionally, one or more sensors 416 may be coupled to the reel 210 and track the radial displacement/rotation of the reel 410 for the TMS 400 to determine a quantity of tether 402 paid out into the tank 202. The motor 412, similar mechanism, and/or the reel 410 may be controlled remotely, semi-autonomously, or autonomously, for example, via the control unit 418 and/or via the power and communications cable 404. A user interface or controller outside the tank 202 may send commands to the control unit 418 or other components of the TMS 400 via a connection to the TMS 400 through the power and communications cable 404.

The TMS 400 also includes a float switch 414 configured to selectively connect the C1D1 cable 404 to the power source 114 such that power/communications are only provided over the C1D1 cable 404 through the TMS 400 and through the tether 402 when the TMS 400 is sufficiently submerged in the flammable fluid 208. In some embodiments, the float switch 414 may be a different type of switch, such as a pressure switch, an optical switch, or the like, that similarly operates to allow power to connect when the TMS 400 reaches a sufficient depth in the flammable fluid 208 or is otherwise separated sufficiently from the vapor layer 206. For example, in other embodiments, the float switch 414 may instead be a switch designed, constructed or configured to close an electrical contact when a certain set fluid pressure has been reached on its input. The switch can be configured to make contact either on pressure rise or pressure fall. The switch can detect mechanical force. The switch can be configured with various types of sensing elements to detect or sense pressure. For example, the switch can include a capsule, bellows, Bourdon tube, diaphragm or piston element that deforms or displaces proportionally to applied or detected pressure. The pressure sensing element of the switch can be arranged to respond to a difference of two pressures. The resulting motion can be applied directly, or through amplifying levers, to a set of switch contacts to allow powering of the TMS 400, the tank inspection vehicle 101, and/or the control unit 418 by closing an electronic circuit between the TMS 400 and the power source 114. In other embodiments, the float switch 414 may be located on the TMS 400 above any component that poses a danger if powered while in the vapor layer. In this way, the float switch 414 may reach the surface of the flammable fluid while such components remain submerged. Accordingly, the change in a buoyant force associated with the float switch 414, the change of the weight of fluid above the float switch 414, or the like may close an electric circuit/connector providing power to the vehicle and TMS 400 when non-HAZLOC certified components are submerged but may disconnect such components when the float switch reaches/approaches the surface, indicating that the non-HAZLOC certified components are also approaching the surface/vapor layer.

The float switch 414 can be configured to operate in a flammable fluid by having an enclosure to prevent an arc at the contacts from igniting the surrounding gas. The switch enclosure can be formed of a material that can be non-flammable, weatherproof, corrosion resistant, or submersible. The float switch 414 can close an electrical contact to power the TMS 400, the vehicle 101, and/or the control unit 418 responsive to detecting sufficient submergence or a threshold pressure. The threshold pressure can correspond to the TMS 400 or the components thereof (e.g., the tether 402) being submerged at least 1 meter, 2 meters, 3 meters or more in a fluid. In some embodiments, the float switch 414 may switch off power to the TMS 400 and the tether 402 when the tether 402 approaches about 300 mm of the vapor layer 206. The float switch 414 can be designed, constructed or operational to detect the depth based on a known density of the fluid. The pressure can be determined based on P=height*density*acceleration of gravity. The threshold pressure can be set based on determining the desired depth at which the TMS 400, the tank inspection vehicle 101, and/or the control unit 418 is to be powered on (e.g., 0.5 meters, 1 meter, 2 meters, 3 meters, or more), the density of the fluid (e.g., 0.7 kg/m3, and gravity (e.g., 9.8 m/s2). The float switch 414 can be configured to power on the TMS 400, the tank inspection vehicle 101, and/or the control unit 418 responsive to detection of the threshold pressure.

The TMS 400 may also include one or more sensors 416. The sensors 416 may include optical sensors, ultrasound sensors, radar, LIDAR, laser distance, or other proximity sensors to determine a position of the TMS 400. Alternatively, the sensors 416 could include strain gauges or load cells affixed to the power and communications cable 404 and configured to detect a tension, slack length, or angle of the power and communications cable 404. In this way, in embodiments where the TMS 400 includes a float 408 which may navigate or wander atop of the surface of the flammable fluid 208, the sensors 416 may determine a location of the TMS 400 atop the surface of the flammable fluid 208 and relative to the roof manway 204 such that the location of the roof manway 204, the TMS 400, and the vehicle 101 are all known. Knowing all three locations can enable an operator or the TMS 400 to determine an appropriate length of tether 402 to let out or spool in as the TMS 400 floats atop the surface of the flammable fluid 208 and the tank inspection vehicle 101 simultaneously travels below the surface in the tank 202. For example, the sensors 416 may detect that a floating TMS 400 is wandering/drifting away from the tank inspection vehicle 101 as the TMS 400 floats atop the surface. Accordingly, the TMS 400 may pay out additional tether 402 to compensate for the degree/magnitude of drift.

The TMS 400 can use a temperature sensor (e.g., sensor 416) to indicate the temperature of the TMS 400, such that the TMS 400 recovery can be delayed until the system has cooled down to remove any risk of ignition when crossing the vapor layer 206 during recovery.

### Exemplary Systems, Methods, and Apparatus for an Externally Powered Tank Inspection Robot

The systems, apparatuses, and methods disclosed below regarding an externally powered tank inspection vehicle 101 and data processing systems associated therewith may be used in tandem with the TMS 400 described above.

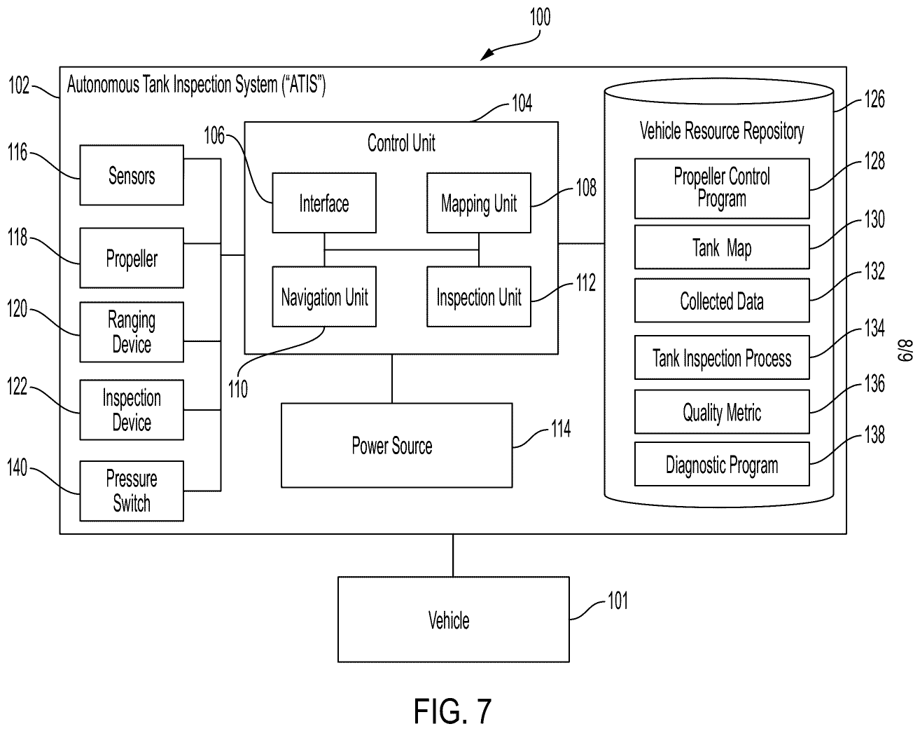

Referring to FIG. 7, a block diagram of an example system to inspect a tank containing a flammable fluid, in accordance with an implementation of the TMS 400, is shown. The system 100 includes a vehicle 101 (e.g., an externally powered tank inspection robot) and a tank inspection system 102 for performing tank inspection. The tank inspection system may be an autonomous tank inspection system (“ATIS”), a semi-autonomous tank inspection system (e.g., autonomous with supervisory control from an operator), or a remote tank inspection system (e.g., controlled by an operator). For exemplary purposes, the embodiment shown and discussed with respect to FIG. 7 illustrates an ATIS 102, however the features discussed may also be utilized by a semi-autonomous or remote tank inspection system 100, TMS 400, and vehicle 101. The ATIS 102 can include at least one control unit 104, at least one power source 114, at least one sensor 116, at least one propeller 118, at least one ranging device 120, at least one inspection device 122, or at least one vehicle resource repository 126. The vehicle resource repository 126 can store software or data associated with the vehicle, including programs, instructions, or data collected by sensors 116. The ATIS 102 can include hardware or a combination of hardware and software, such as communications buses, circuitry, processors, communications interfaces, among others. The autonomous tank inspection system 102 can reside on or within a corresponding vehicle 101.

The vehicle 101 can perform the tank inspection process 134 using power provided by the power source 114. The power source 114 can provide power to one or more component of the vehicle 101, including, for example, the control unit 104, sensors 116, propeller 118, ranging device 120, inspection device 122, or data repository 126. The TMS 400 may act as an intermediate connection between the vehicle 101 and the components thereof and the power source 114. In this way, the TMS 400 may selectively connect/disconnect the vehicle 101 from the power source. For example, the TMS 400 may disconnect a switch or connection when the vehicle 101 and/or the tether 402 are within a designated distance of the vapor layer, are not submerged in flammable fluid, etc.

The control unit 104 can execute a tank inspection process 134 to inspect the tank. The tank inspection process 134 can include instructions to generate a map of the tank 202 or to determine a quality metric 136 for a portion of the tank 202 corresponding to a location of the generated tank map 130. The control unit 104 can perform or execute the one or more instructions of the tank inspection process 134 when the vehicle 101 is submerged in the flammable fluid 208.

Each of the components of the ATIS 102 can be implemented using hardware or a combination of software and hardware. Each component of the ATIS 102 can include logical circuitry (e.g., a central processing unit or CPU) that responds to and processes one or more instructions fetched from a memory unit (e.g., memory, storage device, or vehicle resource repository 126). Each component of the ATIS 102 can include or use a microprocessor or a multi-core processor. A multi-core processor can include two or more processing units on a single computing component. Each component of the ATIS 102 can be based on any of these processors, or any other processor capable of operating as described herein. Each processor can utilize instruction level parallelism, thread level parallelism, different levels of cache, etc. For example, the ATIS 102 can include at least one logic device such as a computing device or server having at least one processor.

The components or elements of the ATIS 102 can be one or more separate components, a single component, or a part of the ATIS 102. For example, the control unit 104 (or the other components of the ATIS 102) can include one or more combinations of hardware and software, such as one or more processors configured to initiate stop commands, initiate motion commands, and transmit or receive timing data. The one or more components can work individually external to the ATIS 102. The one or more component of the ATIS 102 can be hosted on or within a vehicle 101. The components of the ATIS 102 can be connected or communicatively coupled to one another. The connection between the various components of the ATIS 102 can be wired or wireless, or any combination thereof.

The vehicle 101 can include the autonomous tank inspection system (“ATIS”) 102 to inspect the tank containing a flammable fluid. The vehicle 101 can include a transducer to transmit a plurality of acoustic signals. The vehicle 101 can be constructed using one or more materials including steel, stainless steel, aluminum, iron, glass, rubber, plastic, or titanium. The vehicle 101 can include one or more wheels and one or more propellers. The wheels can be constructed with one or more materials similar to the vehicle 101. The wheels can be designed as standard/fixed wheel, orientable wheel, ball wheel, Omni wheel, Mecanum wheel, or continuous track. The vehicle 101 can perform one or more tasks by the control unit 104. The tank and the flammable fluid can be referred to in FIG. 1.

In some implementations, the vehicle 101 can include one or more propellers 118 which can be driven by a motor, but not include any wheels. The wheels may be absent from the vehicle 101 because the one or more propellers can propel or move the vehicle 101 through the flammable fluid in the tank. The vehicle 101 can include one or more wheels driven by a motor. In some cases, the vehicle 101 can include wheels but not a motor to drive the wheels. For example, the wheels may not be motor driven because the propeller 118 can propel or move the vehicle 101 through the flammable fluid in the tank. The vehicle 101 can include one or more fans (e.g., blower fan or axial fan) or heat sinks inside the body that can cool, reduce, maintain, or otherwise manage a temperature of physical components of the ATIS 102.

In some implementations, the vehicle 101 can operate in one or more orientations. The orientations indicating a tilt of the vehicle 101, for example, a 30 degrees tilt or a 180 degrees tilt (e.g., upside-down orientation). The one or more wheels can be located at the front, back, side, or bottom of the vehicle, for example. The vehicle 101 can include the one or more wheels on one or more surfaces of the vehicle 101, for example, the wheels can be included on top of the vehicle 101 which can move the vehicle 101 during a reverse or an upside-down orientation. The vehicle 101 can configure the one or more wheels located on the one or more surfaces based on the orientation of the vehicle 101.

The vehicle 101 can be coated with non-flammable solution or an insulator. The non-flammable solution or insulator can be applied by spray coating, paint coating, attachment, or sheet cover. The non-flammable solution can include glass, mineral wool, gypsum, or magnesium. The insulator can include glass fiber, polyurethane, clay, or ethylene propylene diene terpolymer (“EPDM”) rubber. The vehicle 101 can be coated with linked or merged non-flammable solution and insulator to form a protected layer. The non-flammable solution and insulator can be selected based on the flammable fluid contained inside the tank. The vehicle 101 can incorporate the protected layer for flammable environment, for example, the vehicle can be submerged in the tank containing a flammable fluid. The vehicle 101 can be further coated with water resistance solution including durable water repellent (“DWR”). The vehicle 101 coated with DWR can be hydrophobic, which can prevent fluid from entering the vehicle 101. The one or more coating of the vehicle 101 can be coated on the exterior of the vehicle 101 or embedded into the vehicle 101 containing the ATIS 102. The vehicle 101 can operate under mild environment, for example, below freezing temperature or above boiling temperature. The vehicle 101 can operate under submerged environment or on dry environment, such as to perform an in-service tank inspection by submerging the vehicle 101 under the flammable fluid, for example. The vehicle 101 can be re-coated based on the solubility of the coating exposed to the flammable fluid. However, in some cases, the vehicle 101 may not be coated with a non-flammable solution or insulator and perform an in-service tank inspection due to the vehicle 101 using a battery, cable and remaining powered off as the vehicle 101 traverses a vapor layer and until fully submerged in the flammable fluid.

The vehicle 101 can be constructed to prevent sparks or electrostatic discharge. The vehicle 101 can be constructed with one or more insulated layers to prevent sparks or electrostatic discharge. The one or more insulated layers can include a spark protection layer, which can be, for example, a rubber layer between one or more layer of steels, preventing accidental collision between the steel layers which can cause a spark. The vehicle 101 can be equipped with a non-sparking tool or at least one anti-static tool. The non-sparking tool can be characterized by lack of ferrous metals including steel or iron, which can prevent ignition of sparks under certain condition. The vehicle 101 and the ATIS 102 can be grounded by the anti-static tool, which can prevent static electricity build up to cause an ignition. The vehicle 101 can equip the non-sparking tool or the anti-static tool to operate inside the tank containing the flammable fluid, which can prevent the vehicle 101 from igniting sparks caused by grinding one or more vehicle 101 layers or the building up of electrostatic discharge caused by the power source 114 supplying power to the ATIS 102, for example. The vehicle 101 can include housing for the one or more components of the ATIS 102, which can be constructed using similar materials to the vehicle 101.

The vehicle 101 can operate under dense flammable environment. The dense flammable environment can include ethanol, gasoline (petrol), diesel, oil, or jet fuel. The vehicle 101 can maintain a temperature lower than an ambient temperature, an autoignition temperature, or a flash point. The autoignition temperature can indicate a temperature point at which a substance can be ignited in normal atmosphere without an external source of ignition. The flash point can indicate the lowest temperature at which vapors of the material will keep burning after an ignition source is removed. For example, gasoline can include an autoignition temperature of 280 Celsius and a flash point of 43 Celsius. The vehicle 101 can use a temperature sensor of the ATIS 102 to indicate the temperature of the vehicle 101, such that the vehicle 101 can initiate an operation condition upon the temperature exceeding certain threshold, for example. The operation condition can lower the speed of the propeller 118, pause the vehicle 101, or stop the vehicle 101 operation. The vehicle 101 can determine the speed of the propeller 118 or inspection time, based on the density of the dense flammable environment. For example, a vehicle submerged in gasoline can determine a first speed of one or more propellers configured for a density of 750 kg/m³, and a second vehicle similar to the first vehicle submerged in diesel can determine a second speed, faster than the first speed, of one or more propellers configured for a density of 830 kg/m³.

The vehicle 101 can determine, based on the control unit 104 using a diagnostic program 138, a malfunction of one or more components of the ATIS 102, which can be based on a signal received from the components or a discontinued electrical signal to the components. The vehicle 101 can further determine to use a different component, based on the malfunctioned components, to continue inspecting the tank, for example, the vehicle 101 can determine, based on a malfunctioned propeller 118 due to the propeller 118 not receiving power, to continue the tank inspection using the one or more wheels to drive the vehicle 101, if the vehicle 101 is configured with a propeller 118 and wheels, for example.

The power source 114 can provide power to the vehicle 101 and the components of the ATIS 102. The power source 114 can be external power source such as a generator, fuel cell, battery bank or the like located outside the tank 202. The power source 114 may be attached to the vehicle 101 via the TMS 400, which may selectively disconnect the vehicle 101 from the power source 114. The vehicle 101 or a component of the power source 114 can be equipped with a temperature sensor. The temperature sensor can determine the temperature of the power source 114, which can indicate a thermal dissipation of the power source 114. The vehicle 101 or ATIS 102 can use the measured or detected temperature of the power source 114 to initiate or change an operation condition associated with the vehicle 101, ATIS 102, the TMS 400, the tank inspection process or proper control program. For example, a temperature sensor may be coupled to the motor 412 of the TMS 400 as the tether 402 is wound/unwound during operation of the tank inspection vehicle 101. In response to the temperature rising above a threshold temperature, the vehicle 101, the TMS 400, and/or one or more control units 104, 418 may pause or slow down operations of the TMS 400, cease delivering power to the TMS 400, etc. Operation conditions can include, for example, an exit condition, waiting condition, low power state, cooling state, or high-performance state. For example, the diagnostic program 138 can access the temperature information of the power source 114 and initiate the cooling state based on the temperature reaching a threshold temperature set by the ATIS 102 or initiate the wait condition based on the temperature exceeding the threshold temperature by a predetermined amount. The predetermined amount can be configured prior to the vehicle 101 initiating the tank inspection process 134.

The power source 114 may be external to the vehicle 101 and the tank 202, and thus provide for a housing of the vehicle 101 with reduced size (e.g., a housing that omits a battery compartment). The housing can include a temperature sensor, which can indicate the temperature of the housing. The housing temperature can be used to initiate or change an operation condition upon exceeding a temperature threshold of the diagnostic program 138. The temperature threshold can be determined or set based on the type of a flammable fluid, such as ethanol, gasoline (petrol), diesel, or jet fuel, a dimension of the tank, the construction of the vehicle 101, or a location of the tank.

The power source 114 can provide an indication of power available to the control unit 104, which can be used by the diagnostic program 138. The indication of power available can be used to determine an operation condition by the diagnostic program 138 of the control unit 104. For example, the power available can be used to determine a speed setting of the propeller 118, such that the ATIS 102 operates on high performance state prior to reaching a first power threshold, operates on low power state based on reaching the first power threshold, or execute the exit condition based on the power available reaching a second power threshold lower than the first power threshold.

The sensors 116 can include a proximity sensor, touch sensor, accelerometer, angular rate sensors, gyroscopes, speed sensor, torque sensor, pressure sensor, temperature sensor, light sensor, electrical charge sensor, electrical current sensor, electrostatic sensor, position sensor, tilt sensor, pitch, roll and heading sensor, or odometer. The sensors 116 can be connected to the power source 114. The sensors 116 can be attached to the vehicle 101 or embedded inside the vehicle 101 such as in front, back, above, side, or underneath the vehicle 101. The sensors 116 can collect one or more information of the vehicle 101 or the ATIS 102 including vehicle speed, propeller torque, component temperature, vehicle travel distance, or vehicle touch information. The vehicle 101 can determine the vehicle state (e.g., accelerations, angular rate, attitude and heading, depth, or position). The sensors 116 can provide data or measurements to the navigation unit 110, which can determine the state of the vehicle 101 (e.g., accelerations, angular rate, attitude and heading, depth, or position).

The vehicle 101 can include a pressure switch 140. The pressure switch can be designed, constructed or configured to close an electrical contact when a certain set fluid pressure has been reached on its input. The pressure switch 140 can be configured to make contact either on pressure rise or pressure fall. The pressure switch 140 can detect mechanical force. The pressure switch 140 can be configured with various types of sensing elements to detect or sense pressure. For example, the pressure switch 140 can include a capsule, bellows, Bourdon tube, diaphragm or piston element that deforms or displaces proportionally to applied or detected pressure. The pressure sensing element of the pressure switch 140 can be arranged to respond to a difference of two pressures. The resulting motion can be applied directly, or through amplifying levers, to a set of switch contacts to power on the vehicle 101 or control unit 104 by closing an electronic circuit between the control unit 104 and the power source 114.

The pressure switch 140 can be configured to operate in a flammable fluid by having an enclosure to prevent an arc at the contacts from igniting the surrounding gas. The switch enclosure can be formed of a material that can be non-flammable, weatherproof, corrosion resistant, or submersible.

The pressure switch 140 can close an electrical contact to power the control unit 104 responsive to detecting a threshold pressure. The threshold pressure can correspond to the vehicle 101 being submerged at least 1 meter, 2 meters, 3 meters or more in a fluid. The pressure switch 140 can be designed, constructed or operational to detect the depth based on a known density of the fluid. The pressure can be determined based on P=height*density*acceleration of gravity. The threshold pressure can be set based on determining the desired depth at which the control unit 104 is to be powered on (e.g., 1 meter, 2 meters, 3 meters, or more), the density of the fluid (e.g., 0.7 kg/m³, and gravity (e.g., 9.8 m/s²). The pressure switch 140 can be configured to power on the control unit 104 responsive to detection of the threshold pressure. The pressure switch 140 can be configured to power on the vehicle 101 responsive to the pressure exceeding the threshold pressure.

The sensors 116 of the vehicle 101 can include a fuel level sensor. In some cases, the vehicle 101 can derive or determine the fuel level via an external fuel level sensor or by not using a separate fuel level sensor. For example, the vehicle 101 can derive the fuel level based on its depth and altitude above the floor. In another example, the vehicle 101 can receive the fuel level information from an external source (e.g., checking the mechanical level gauges installed in or on a tank) prior to deployment into the tank the mechanical level gauges usually installed in tanks. The vehicle 101 can determine the fuel level based on the density of the flammable fluid, the pressure sensor in the vehicle, and an acoustic speed sensor (which can provide altitude above the floor). The vehicle 101 can determine the depth and altitude based on the pressure, which can indicate the liquid level. In some cases, the vehicle 101 can determine the fuel level from a gauge configured on the tank.

The information identified by the sensor 116 can be stored in the collected data 132 within the vehicle resource repository 126, which can be accessed by the control unit 104. The sensor 116 can perform an operation by the control unit 104. The operation can include sensor selection, sensor initiation, or sensor deactivation. The sensor selection can select a sensor 116 from multiple sensors based on one or more commands to be executed by the control unit 104. The sensor initiation can activate at least one sensor 116 to perform the one or more commands, and the sensor deactivation can deactivate at least one sensor 116 upon completing the one or more commands. For example, sensor initiation and deactivation can include selecting the proximity sensor to identify obstruction within the tank for collision avoidance, activating the sensor 116 to obtain proximity data of the tank, and deactivating the sensor 116 upon storing the collected data in the data repository, indicating completion of the one or more commands.

The sensors 116 information can configure or determine a plurality of settings for one or more components of the ATIS 102, for example, using the temperature sensor to determine an operation condition of the vehicle 101. The temperature sensor can be included in or on the power source 114, the propeller 118, or one or more portions of the vehicle 101 to determine the temperature information, wherein the temperature information can be stored in the collected data 132. The temperature sensor can detect changes in temperature based on changes in the one or more substances of the temperature sensor, the changes in the substance can be an expansion or contraction of mercury inside the sensor 116 container. The temperature information can be accessed by the control unit 104 executing the diagnostic program 138 to determine an operation condition of the one or more components of the system 100. The diagnostic program 138 can determine to change the operation condition based on the temperature reaching a first threshold, or to initiate the operation condition based on the temperature reaching a second threshold, for example, the diagnostic program 138, initiating the low power state, decrease the propeller speed based on the temperature of the power source 114 reaching the first threshold and initiate the exit condition to stop the vehicle 101 from executing a command based on the power source 114 reaching the second threshold.

The sensors 116 and the ranging device 120 provide data used by the navigation unit 110 to determine the position of vehicle 101 as it moves along its desired path in the tank. The navigation unit 110 can determine or configure the navigation path using the sensors 116. The proximity sensor can be attached or embedded in front of the vehicle 101 to detect nearby object for collision avoidance without physical contact with the object. The proximity sensor can emit an acoustic beam or beam of electromagnetic radiation (e.g., a laser range finding system), and measure travel time to determine the present of one or more objects, which can be referred to as one or more targets. For example, the navigation unit 110, based on the proximity sensor detecting obstruction in close proximity of the vehicle 101, can responsively maneuver the vehicle 101 to avoid collision. A combination of measurements from sensors 116 and the ranging device 120 can be used to determine the vehicle's position over time and generate a map of the tank. For example, the ranging device 120 can determine the position of the vehicle 101 relative to the side of the tank. The ranging device 120 can use sensors 116, or other sensors, for dead reckoning (e.g., the process of determining the position of the vehicle 101 by estimating the direction and distance traveled). In some cases, the sensor 116, such as the odometer, can be used to determine total distance travelled by the vehicle 101. The total distance can be used to generate a map of the tank, determine an operation efficiency of the tank inspection, determine a resource utilization value of the tank inspection, or an amount of power consumed by the vehicle 101 during the tank inspection process.

The sensors 116 can provide fuel level information using the fuel level sensor embedded in or on the vehicle 101 indicating an amount of fuel remaining in the tank during inspection. The fuel level sensor can include a float, an actuating rod, and a resistor, which can provide a signal indicating the amount of fuel in residing in the tank. The fuel level sensor on the vehicle 101 can provide information to determine a submersion level of the vehicle 101. The submersion level can be used by the control unit 104 to initiate the diagnostic program 138. The fuel level sensor can be used to determine or configure an operation condition based on the tank dimension. The sensors 116 can determine the tilt information using the tilt sensor, indicating the orientation of the vehicle 101. The tilt sensor can be used by the control unit 104 to prevent disorientation of the vehicle 101. Disorientation can refer to the vehicle 101 being upside down, or otherwise oriented in an incorrect or erroneous direction.

The vehicle 101 can be powered on based on a pressure threshold. The pressure threshold can be predetermined prior to executing a tank inspection procedure, such as before inserting the vehicle 101 into the launcher connected to the manway of the tank. The vehicle 101 can measure the surrounding pressure using at least the pressure sensor of the vehicle 101. For example, the pressure threshold can be set to 40 pound per square inch (“PSI”). The vehicle 101 can initially be powered off under 15 PSI of pressure. The pressure surrounding the vehicle 101 can increase from 15 PSI to 45 PSI. In response to the pressure exceeding 40 PSI (i.e., the pressure threshold), the vehicle 101 can turn on and execute instructions to perform tank inspection procedures.

In some implementations, the pressure threshold can be dynamically adjusted based on at least the pressure or the condition surrounding the vehicle 101. The condition surrounding the vehicle 101 may refer to whether the vehicle 101 is in contact with a fluid or is not in contact with the fluid. For example, the pressure threshold can entail a pressure 20 PSI greater than a starting pressure surrounding the vehicle 101. The starting pressure can refer to a pressure measurement an instance prior to the vehicle 101 being in contact with a fluid. The vehicle 101 can receive, using the pressure sensor, a first pressure measurement of 15 PSI. The vehicle 101 may be moved to a different location prior to turning on the vehicle 101. The vehicle 101 may receive, using the pressure sensor, a second pressure measurement of 17 PSI. The second pressure measurement can be the starting pressure for turning on the vehicle 101. The pressure surrounding the vehicle 101 may increase from 17 PSI to 45 PSI, while the vehicle 101 is in contact with a fluid. Subsequent to the pressure exceeding 37 PSI (i.e., the pressure threshold above the starting pressure) and the vehicle 101 being in contact with the fluid, the vehicle 101 can turn on to execute tank inspection instructions.

The vehicle 101 may exit the tank via a manway of the tank. The vehicle 101 can use sensors 116 to navigate back to the location of the manway, such as a position adjacent to the TMS 400 or in a proximity (3 ft, 5 ft, etc.) of a region directly below the roof manway 204. Accordingly, once the vehicle 101 in position, external power may be shut off or disconnected from the vehicle 101, and an operator may hoist/remove the TMS 400 and/or the vehicle 101 from the tank 202 (e.g., via the roof manway 204).

The propeller 118 can include a controllable-pitch propeller, skewback propeller, modular propeller, or Voith Schneider propeller. The propeller 118 can be connected to the power source 114. The propeller 118 can use the one or more sensors 116 to determine one or more propeller information including a propeller speed, a propeller torque, or a propeller motor temperature. The propeller information can be stored within the collected data 132 of the vehicle resource repository 126. The propeller 118 can execute one or more commands by the navigation unit 110 of the control unit 104 using the propeller control program 128 stored in the vehicle resource repository 126, which can be based on an execution of a diagnostic program 138. The control unit 104 can increase or decrease the speed of the propeller 118 to adjust the vehicle 101 speed or change the orientation of the propeller 118 to adjust the direction of the vehicle 101. The control unit 104 can adjust the speed or orientation of the vehicle responsive to or based on the results of executing the diagnostic program 138, or a location of the vehicle 101 on the map of the tank. In some cases, the control unit 104 can disable or turn off the propeller 118 responsive to the results from executing diagnostic program 138. For example, the diagnostic program 138 can identify a failure of a component or an undesired operating condition. The control unit 104, based on the failure or operating condition, can determine not to provide power to the propeller 118. Instead, the control unit 104 can determine to re-run the diagnostic program 138 one or more times until a satisfactory operating condition has been detected.

The propeller 118 can be used to rotate or move the vehicle 101 through the flammable fluid in the tank in one or more directions based on the navigation unit 110 using the propeller control program 128. The propeller 118 can be configured with an operation condition to increase or decrease the propeller speed. In some cases, the propeller 118 can be configured by the diagnostic program 138 to operate in a low power state based on the amount of power or energy remaining in the power source 114. The propeller 118 can operate in a cooling state, based on the temperature information of the power source 114 or the propeller 118. In some cases, the control unit 104 can be configured with a wait condition in which the control unit 104 pauses the propeller 118 responsive to a condition (such as heat buildup or a buildup in electrostatic charge as detected by a sensor 116).

The ranging device 120 can include a bump sensor, infrared sensor, ultrasonic sensor, laser sensor, or radar sensor. The ranging device 120 can be controlled, instructed or managed by the mapping unit 108 of the control unit 104 to execute one or more mapping commands. The ranging device 120 can be connected to the power source 114. The ranging device 120 can provide data to the mapping unit 108 to generate or update a map of the tank based on information from the one or more components of the ranging device 120. The ranging device 120 can collect data used to generate or update the map of the tank based on the vehicle 101 traversing a plurality of portions of the tank. The ranging device 120 can determine, maintain, or update a position of the vehicle 101. The ranging device 120 can be configured by the mapping unit 108 of the control unit 104, for example, to update the position of the vehicle 101. The map of the tank generated by the ranging device 120 can be included, stored, maintained, and updated within a tank map 130 of the vehicle resource repository 126. The mapping unit 108 can use information obtained from any sensors 116 or other sources to generate the map, including, but not limited to, for example the ranging device 120 and sensors 116.

The ranging device 120 can include or use the radar sensor to measure distance between the vehicle 101 and the enclosure of the tank using radio waves with an antenna. The antenna can transmit the radio waves and receive a reflection of the radio waves, the reflection of the radio waves can indicate the enclosure of the tank, which can indicate the dimension of the tank. The dimension of the tank can be stored within the tank map 130. The ranging device 120 can use the ultrasonic sensor to measure the distance between the vehicle 101 and the enclosure of the tank. The ultrasonic sensor can include an ultrasonic element for both emission and reception of ultrasonic waves, the ultrasonic element can emit the ultrasonic waves, initiate a timer, receive the ultrasonic waves, and stop the timer. The ultrasonic sensor can execute a distance measurement technique to determine the distance between the vehicle 101 and the enclosure of the tank. The ranging device 120 can generate the tank map 130 based on acoustic waves reflected off one or more portions of the tank, the acoustic waves generated by the one or more ranging device 120 sensors. In this way, the location data related to the vehicle 101, the tank 202, and/or the TMS 400 may cause a corresponding length of tether 402 to be reeled out or reeled in such that the vehicle 101 may navigate unhindered in the tank 202.

The inspection device 122 can include a magnetic sensor, a magnetic sensor array, an ultrasonic sensor, an ultrasonic array system, an ultrasonic phased array system, or a sweeping device. The inspection device 122 can be connected to the power source 114. The inspection device 122 can be configured by the inspection unit 112 of the control unit 104 to execute one or more commands. The inspection device 122 can inspect the tank to make quality metric measurements, such as measurements related to the thickness or level of corrosion of a portion of the tank. The inspection device 122 can initiate a tank inspection process 134 to make quality metric measurements for portions of the tank. The tank inspection process 134, which can be retrieved from the vehicle resource repository 126, which can be subsequent to the generation of a portion of a tank map 130. The tank inspection process 134 can be based on the result of the diagnostic program 138. The ATIS 102 can store the inspected portion of the tank within the tank map 130 in the vehicle resource repository 126. The inspection device 122 can determine a quality metric 136 of a portion of the tank. The quality metric 136 can include or indicate the thickness of a portion of the tank, or a level of corrosion of a portion of the tank. The vehicle 101 can determine and store the quality metric 136 in the vehicle resource repository 126. The inspection device 122 can execute the inspection process 134 responsive to identifying that a portion of the tank map 130 has not yet been inspected. The inspection device 122 can, however, determine not to execute the inspection process 134 responsive to identifying that the portion of the tank map 130 has already been inspected, thereby reducing computing and energy resource consumption by the vehicle 101.

The inspection device 122 can use the magnetic sensor or magnetic sensor array to determine the thickness of the tank floor. The magnetic sensor can include one or more coils or one or more conductors that can generate a magnetic field. The inspection device 122 can induce loops of electric current at one or more portions of the tank corresponding to a first position of the vehicle 101 on the tank map 130. The position can refer to a region, area or section of the tank. The control unit 104 can provide instructions or commands to the inspection device 122 to cause the inspection device 122 to modify the magnitude, intensity, or duration of the magnetic field generated by the conductors. For example, the control unit 104, executing the inspection process 134, can generate control commands and output the commands to the inspection device 122.

The inspection device 122 can detect or measure values corresponding to the induced loops of electric current at the one or more portions of the tank. The measured values can correspond to a property of the magnetic field, such as a magnitude, intensity, or decay time, and can be stored in the collected data 132 of the vehicle resource repository 126. The control unit 104 can receive the detected or measured values from the inspection device 122 and process the values to determine a quality metric. The control unit 104 can store the received values as collected data 132 for future processing by the ATIS 102 or an external data process system. To process the values, the inspection unit 112 can use a thickness table (e.g., stored in the vehicle resource repository 126) to convert the measured values associated with the magnitude field to tank floor thickness, which can be stored in the quality metric data structure 136.

The vehicle 101 can include a sweeping device to remove debris that might negatively affect measurements related to the quality metric. For example, the sweeping device can remove substances between the tank enclosure and the inspection device 122 (or sensors 116). The vehicle 101 can measure values after sweeping to obtain an accurate measurement. The vehicle 101 can measure values before and after sweeping to determine the variation or impact on the measurement caused by the debris.

The inspection device 122 can generate pulsed eddy currents to determine the quality metric 136. The inspection device 122 can include a pulsed eddy currents probe to determine a thickness or a corrosion of the tank floor using the pulsed eddy current. The magnetic field can penetrate through the one or more layers or constructions of the tank floor and stabilize in the layer of the tank floor. The electrical current generated by the inspection device 122 can be disabled to cause a drop in the magnetic field, which results in eddy currents appearing in the layers of the tank floor and decreasing strength over time. The pulsed eddy currents probe can be used to monitor the decay in eddy current, the decay can determine the thickness of the tank floor. The electrical current magnitude in a given loop can be proportional to the strength of the magnetic field, the area of the loop, and the rate of change of flux, and inversely proportional to the resistivity of a material.

In some implementations, the inspection device 122 can generate array eddy currents along an array of coils to determine the quality metric 136 at a portion of the tank corresponding to a second position of the vehicle 101 on the tank map 130. An alternating current can be injected into the coil of the inspection device 122 to create a magnetic field. The inspection device 122 can be placed over the tank floor to generate one or more opposed alternating current. The inspection device 122 can then determine a flaw or corrosion of the tank floor based on the measured distortion of the opposed alternating current.

The inspection device 122 can include an ultrasonic array system or ultrasonic phased array system to determine a second quality metric 136 at the portion of the tank corresponding to the first position of the vehicle 101 on the tank map 130. The second quality metric 136 can be similar to, or different from, the first quality metric 136. The ultrasonic phased array system can include ultrasonic transducers, which can be pulsed independently using computer-calculated timing. Pulsing the ultrasonic transducers can result in steering a beam generated by the ultrasonic transducers to scan the portions of the tank. In some implementations, the inspection device 122 can include two different technologies to generate the quality metric 136 at the portion of the tank. For example, the inspection device 122 can determine a thickness of the tank floor using eddy currents information and a thickness of the tank floor using the ultrasonic phased array information. This allows the vehicle 101 to take advantage of the complementarity of the two technologies. For example, eddy current technology can provide better results compared to ultrasonic technology in the presence of residual sediment after the brush cleans the floor, or in the case the tank floor inside the tank (e.g., topside) is corroded corrosion. Ultrasonic can provide better results as compared to eddy current technology when the floor has been sufficiently cleaned by the brush and is primarily affected by pitting. In some cases, one technology may consume more power than another technology, so the vehicle 101 can select a lower power technology in the event the power provided by the power source 114 is low in order to prolong the inspection. Thus, the inspection device can include at least two different types of sensors, and select, based on a condition associated with the portion of the tank corresponding to the first position of the vehicle on the map, one of the at least two different types of sensors to inspect the portion of the tank.

The vehicle resource repository 126 can include or store the propeller control program 128, the tank map 130, the collected data 132, the tank inspection process 134, the quality metric 136, and the diagnostic program 138. The propeller control program 128 can include or store one or more propeller commands, the propeller commands can determine propeller speed, torque, and orientation, which can adjust the vehicle 101 speed, distance travel, or direction, for example. The propeller control program 128 can be controlled based on the result of the diagnostic program 138. The propeller control program 128 commands can include moving the vehicle 101 through the flammable fluid in the tank. The propeller control program 128 can be used or updated by the navigation unit 110 of the control unit 104 to control the propeller 118.

In some cases, the propeller control program 128 can be configured by the control unit 104 to operate in high performance state based on the available power of the power source 114 or the tank map 130 dimension. In some cases, the propeller control program 128 can operate in low power state based on the available power reaching a first power threshold. In some cases, the propeller control program 128 can initiate an exit condition based on the available power reaching a second power threshold, lower than the first power threshold. In some cases, the propeller 118 can operate in the cooling state, based on the temperature information of the power source 114 or the propeller 118.

The tank map 130 can include, store, or maintain one or more maps of the tank to generate a path for tank inspection or a map data structure to generate a map of the tank. The map data structure can be stored in the data repository 126, which can be part of the tank inspection process 134. The tank map 130 can store information collected from the ranging device 120, which can be configured by the inspection unit 112 of the control unit 104. The tank map 130 can include or store information on the dimension of the tank, or position information of the vehicle 101 corresponding to the map. The dimension information of the tank can include length, width, height, or the circumference or diameter or radius, which can be used by the navigation unit 110 to set the vehicle 101 speed to move in the tank or by the inspection unit 112 using the tank inspection process 134 to set the inspection speed. The tank map 130 can include or store information on one or more inspected portions or one or more uninspected portions of the map. The tank map 130 can be updated by data received from the ranging device 120.

The collected data 132 can include or store data from the sensors 116, the propeller 118, the inspection device 122, the TMS 400, or the power source 114. The TMS 400 data can include a distance between the vehicle 101 and the TMS 400, a position of the reel 410, a length of tether 402 paid out into the tank 202, a temperature of a TMS 400 component, an operating speed of the motor 412, an estimated proximity between the tether 402 and the vapor layer 206, etc. The sensor data can include the speed of the vehicle 101, speed of the propeller 118, temperature of the vehicle 101 (or portion thereof), temperature of the propeller motor 118, temperature of the power source 114, the travel distance (or position, direction, or heading) of the vehicle 101, the propeller 118 torque, touch information, the magnetic field information, the ultrasonic sensor information. The collected data 132 can store acknowledgement feedback from the propeller 118 as a response to the propeller 118 receiving the control instruction. The collected data 32 can store inspection data obtained by the inspection device 122, including magnetic field information and the ultrasonic sensor information to determine a quality metric 136 of the tank enclosure. The collected data 132 can store diagnostic result from executing the diagnostic program 138. The diagnostic result can be used by the control unit 104 to determine whether to initiate the tank inspection process 134, disable the propeller 118 to prevent the propeller 118 from moving the vehicle, or set a speed of the propeller 118. The collected data can include or store the battery information indicating the power available in the power source 114, the power available can initiate the operation condition by the control unit 104.

The tank inspection process 134 can include or store a plurality of inspection instruction, which can comprise generating the tank map 130 and determining a quality metric 136 for a portion of the tank corresponding to a location on the generated map. The tank inspection process 134 can be configured or used by the inspection unit 112 of the control unit 104 to initiate the inspection device 122. The tank inspection process 134 can be configured based on the result of the diagnostic program 138. The tank inspection process 134 commands can include sweeping instruction for removing sediment on the tank floor, or data collection command for the inspection unit 112 to determine the quality metric 136 of a portion of the tank. The tank inspection process 134 can maintain or update the inspection commands based on the collected data 132 from the inspection device 122, one or more uninspected portions of the tank indicated by the tank map 130, or path of the tank inspection based on the navigation unit 110.

The control unit 104 (e.g., via an inspection unit 112) can retrieve from the vehicle resource repository 126 a tank inspection process 134. The control unit 104 can load, execute, initiate, run or otherwise perform the tank inspection process 134 retrieved from the vehicle resource repository 126. The tank inspection process 134 can include one or more rules, parameters, conditions, operations, procedures, or other information used to perform a tank inspection. For example, the tank inspection process 134 can include a type of tank inspection, such as an expedient, preliminary, or efficient inspection on one or more portions of the tank floor based on the tank map 130. The tank inspection process 134 can execute a type of inspection based on the size of the tank, tank status, vehicle 101 status, or other condition. An expedient inspection process can reduce the amount of time spent inspecting one or more portion of the tank floor. The expedient inspection process can include increasing the speed at which the vehicle 101 moves through the flammable fluid within the tank, or using a wider track spacing than the length of the inspection device such that the tank floor is not fully covered.

In some implementations, the tank inspection process 134 can maintain or update a predetermined duration (e.g., 30 minutes, 1 hour, 2 hours, etc.) for tank inspection based on one or more inspection unit 112 commands. The predetermined duration can be stored in the tank inspection process 134. The tank inspection process 134 can include a timer based on the predetermined duration. The tank inspection process 134 can be initiated the timer based on the vehicle 101 being sealed in the tank, the timer can provide an indication to terminate the tank inspection process 134 based on the timer reaching the predetermined duration (e.g., expiration of the timer).

The quality metric 136 can refer to values, measurements, or determinations made using collected data 132. The quality metric 136 can be generated by applying one or more processes or techniques to the collected data 132. The processing techniques can include, for example, a thickness measurement technique, thickness table, or corrosion level measurement technique. The quality metric 136 can include or indicate computed thickness information which can be obtained by using the stored collected data 132 from the inspection device 122. The quality metric 136 can maintain and update one or more corrosion level corresponding to the portion of the tank map 130 determined by the inspection device 122. The quality metric 136 can indicate the corrosion level for one or more portions of the tank based on a plurality of tank inspection process 134 performed by the vehicle 101 during a time interval. The quality metric 136 can indicate the corrosion level based on a comparison between the computed thickness information of a first portion compared to a previous inspected thickness information of the first portion, which can be from past inspection, or a second portion thickness information different from the first portion using the thickness table. The thickness table can indicate the standard thickness corresponding to the tank, the standard thickness corresponding to the original thickness of the tank prior to filling the tank with the flammable fluid. The thickness table can include a comparison between magnitude, intensity, or decay time of a magnetic field to the thickness of the tank. The quality metric 136 can include or store a comparison metric, identifying corrosion level difference between the one or more portions of the tank.

The diagnostic program 138 can include or store diagnostic instruction for the vehicle 101. The diagnostic program 138 can include or store one or more instructions to at least test one or more functionalities of the sensors 116, the propeller 118, the ranging device 120, the inspection device 122, or the power source 114. The diagnostic program 138 can include one or more policies indicating a condition of the vehicle 101. The condition can include the vehicle 101 at least partially submerged in the flammable fluid or a successful test of the one or more functionalities of the ATIS 102. The condition can be used by the control unit 104 to provide one or more instructions to the component. The diagnostic program 138 can store one or more diagnostic results in collected data 132 of the vehicle resource repository 126. The diagnostic program 138 can disable the propeller 118 to prevent the propeller 118 from moving the vehicle 101 from a position.

The diagnostic program 138 can provide the one or more diagnostic results to the control unit 104 for determining to initiate the tank inspection process 134, or to initiate the operation condition, which can be based on one or more condition of the ATIS 102 components including the power available in the power source 114, the sensors 116 information, the propeller 118 information, the ranging device 120 information, or the inspection device 122 information. The diagnostic program 138 can detect the state of the cable, which can indicate the connection of the cable to the vehicle 101. The operation condition can include an exit condition, a wait condition, a low power state, a cooling state, or a high-performance state. The exit condition can include one or more commands to move the vehicle 101 towards a first portion of the tank map 130 or terminate vehicle 101 operation. The exit condition can be based on an expiration of a timer of the tank inspection process 134. The wait condition can include one or more commands to hold the vehicle 101 operation which can include movement and sensor activation, or initiate a countdown before executing the vehicle 101 operation. The low power state can include one or more commands to decrease the propeller 118 speed, deactivate one or more sensors 116, or execute a quick tank inspection process 134 which can cover more portions of the tank using the available power of the power source 114. The cooling state can include one or more commands to initiate the propeller 118 inside the body of the vehicle 101 to cool the ATIS 102, decrease execution of the ATIS 102, or hold the vehicle 101 operation based on the temperature. The high-performance state can include one or more commands to increase execution of the ATIS 102 which can include activating one or more sensors 116, increasing the propeller 118 speed, or initiating a comprehensive tank inspection process 134.

In some implementations, the control unit 104 can determine to generate the map for the tank based on the vehicle 101 being lowered in the tank. The control unit 104 can then instruct the ranging device 120 using the mapping unit 108 to generate the map for the tank. The map of the tank can be stored in tank map 130. In some implementations, the control unit 104 can identify one or more uninspected portions of the tank based on an absence of indication of inspected one or more portions of the tank map 130. The uninspected one or more portions of the tank can be flagged by the inspection unit 112, the flag can be stored in the tank map 130. The control unit 104 can cause the propeller 118 of the vehicle 101 to move the vehicle 101 towards the identified uninspected portion of the tank. The control unit 104 can initiate the tank inspection process 134 on the uninspected portion using the inspection unit 112. In some implementations, the control unit 104 can identify an absence of any uninspected portions of the floor of the tank based on the tank map 130 generated. The control unit 104 can then provide an indication that the tank inspection process 134 is complete using the exit condition based on identifying the absence of an uninspected portion of the tank. The indication of completing the tank inspection process 134 can comprise an acoustic signal or radio waves.

The interface 106 can include an LCD display, which can include haptic feedback capability for receiving and transmitting information to the control unit 104. The LCD display of the interface 106 can include a graphical user interface which can be used to configure the vehicle 101 setting prior to lowering the vehicle 101 into the flammable fluid. The interface 106 can maintain or update processes of the mapping unit 108, the navigation unit 110, and the inspection unit 112 based on the received or transmitted information. The interface 106 can include one or more ports for external connection to the ATIS 102, such as a serial port, USB port, display port, Ethernet port, or Bluetooth receiver and transmitter. The one or more ports can be used to transfer one or more data to or from the vehicle resource repository 126, such as the propeller control program 128, the tank map 130, the collected data 132, the tank inspection process 134, the quality metric 136, or the diagnostic program 138. The port can be used to charge the power source 114 of the vehicle 101. The interface 106 can be covered by one or more materials for waterproofing.

The mapping unit 108 can provide one or more commands to the ranging device 120, which can be based on the tank map 130, the collected data 132, or the tank inspection process 134. The mapping unit 108 can initiate the map data structure stored in the data repository 126 to generate the map of the tank using the ranging device 120. The mapping unit 108 can be connected to the power source 114. The mapping unit 108 can configure or instruct the ranging device 120 to collect acoustic, electromagnetic radiation, touch or other data associated with the tank. The mapping unit 108 can store the collected data and generate a map of the tank, which can be stored in the tank map 130 located in the vehicle resource repository 126. The mapping unit 108 can determine a first position of the vehicle on the tank map 130. The mapping unit 108 can receive data from the ranging device 120 to generate or update the tank map based on traversing a plurality of points of the tank.

The navigation unit 110 can provide one or more commands to the propeller 118, which can be based on the propeller control program 128, the tank map 130, the operation condition based on the diagnostic program 138 result, or the collected data 132. The navigation unit 110 can configure the propeller 118 to move the vehicle 101 through the flammable fluid in the tank from the first position to the second position, which can be based on the tank inspection process 134. The navigation unit 110 can disable the propeller 118 to prevent the propeller 118 from moving the vehicle 101 from the second position based on the operation condition. The navigation unit 110 can hold the vehicle 101 operation before execution of the diagnostic program 138. The navigation unit 110 can further configure the propeller 118 speed, which can be based on the operation condition, or the location of the vehicle 101. The navigation unit 110 can navigate the vehicle 101 to only the one or more uninspected portions of the tank based on the tank map 130. The navigation unit 110 can navigate the vehicle 101 to cover the entire tank map 130.

The inspection unit 112 can provide one or more commands to the inspection device 122, which can be based on the tank inspection process 134 or the quality of the collected data 132 stored in the vehicle resource repository 126. The inspection unit 112 can identify, based on the collected data 132 using the inspection device 122, the quality of the collected data 132 for the quality metric 136. The quality of the collected data 132 can be based on the inspection device 122, the magnitude of noise obtained by the inspection device 122, or obstruction within the tank, for example, one or more substances covering the tank enclosure can misrepresent the thickness of the tank. The inspection unit 112 can configure the inspection device 122 to inspect the tank based on initiating a tank inspection process 134. The tank inspection process 134 can be based on the operation condition of the diagnostic program 138 result.

The inspection unit 112 can determine the quality metric 136 of a portion of the tank based on the collected data 132 from the inspection device 122, the quality metric 136 indicating a thickness of the portion of the tank at a vehicle 101 position. The quality metric 136 determined by the inspection device 122 can be stored in the vehicle resource repository 126 accessible by the control unit 104. The inspection unit 112 can update the tank inspection process 134 based on the collected data 132, for example, to repeat the tank inspection process 134 on one or more portions of the tank. The inspection unit 112 can re-execute the tank inspection process 134 based on the identified quality of the collected data 132. The inspection unit 112 can configure the inspection device 122 to perform the quick inspection based on the tank map 130 size, or the operation condition, for example, the inspection unit 112 can initiate the quick inspection during the low power state based on the available power of the power source 114 and the one or more uninspected portions of the tank.

### Exemplary Data Processing System for a Tank Inspection Vehicle Utilizing a TMS

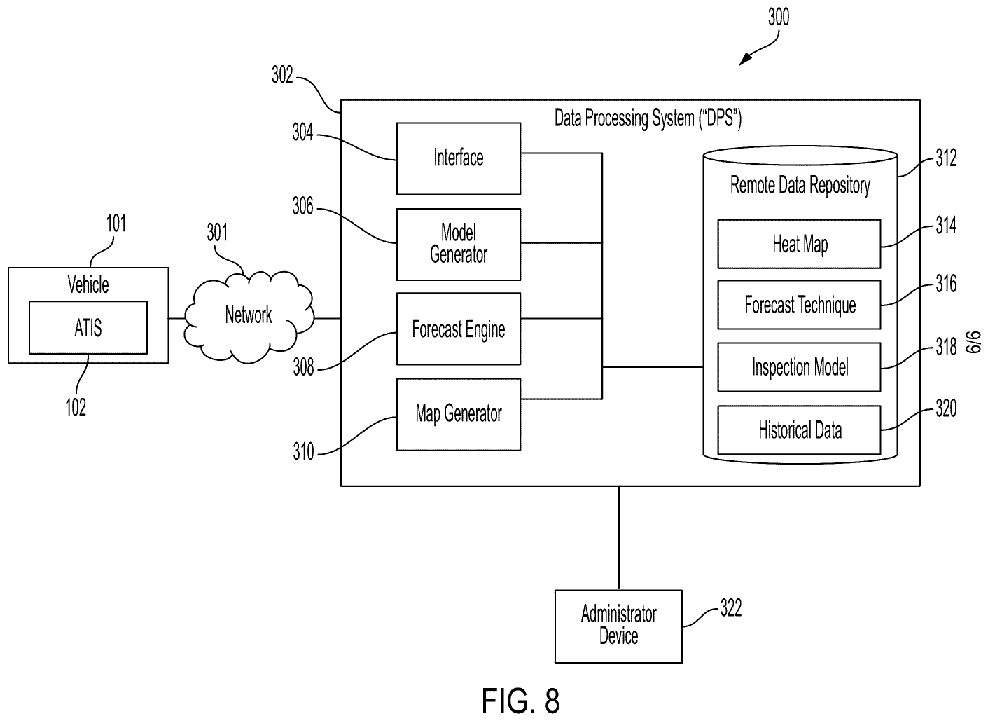

FIG. 8 is a block diagram of an example system to perform a tank inspection operable with a tank inspection vehicle 101 and a TMS 400. The system 300 can include one or more components or functionality of system 100 depicted in FIG. 7. The system 300 can include a vehicle 101, a TMS 400, network connection 301, data processing system (“DPS”) 302, or administrator device 322. The vehicle 101 can include an autonomous tank inspection system (“ATIS”) 102 which can include at least one aspect depicted in FIG. 7. The vehicle 101 can be connected to the network 301 via wired or wireless connection. For example, the vehicle 101 may be selectively connected to the network via an ethernet connection through the TMS 400. The vehicle 101 can be disconnected from the network 301 and operate independent from the data processing system 302. The vehicle 101 can access information from the data processing system 302 via the network 301. The data processing system 302 can be updated or configured by the administrator device 322. The administrator device 322 can be connected wired or wireless to the data processing system 302.

The network 301 can include or refer to a wired or wireless connection, communication, or transfer of information. The network 301 can include computer networks such as the Internet, local, wide, metro, or other area networks, intranets, satellite networks, and other communication networks such as voice or data mobile telephone networks. The network 301 can include a wired connection or communication using, for example, USB, Ethernet, serial port, digital subscriber line (“DSL”), cable, or fiber. The network 301 can transmit information to or receive information from the vehicle 101 via the interface 106 of the vehicle 101.

The network 301 can be any type or form of network and can include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. The network 301 may include a wireless link, such as an infrared channel or satellite band. The topology of the network 301 may include a bus, star, or ring network topology. The network may include mobile telephone networks using any protocol or protocols used to communicate among mobile devices, including advanced mobile phone protocol (“MPS”), time division multiple access (“TDMA”), code-division multiple access (“CDMA”), global system for mobile communication (“GSM”), general packet radio services (“GPRS”) or universal mobile telecommunications system (“UMTS”). Different types of data may be transmitted via different protocols, or the same types of data may be transmitted via different protocols.

The data processing system 302 can include an interface 304, a model generator 306, a forecast engine 308, a map generator 310, or a remote data repository 312. The data processing system 302 can include hardware or a combination of hardware and software, such as communications buses, circuitry, processors, communications interfaces, among others, similar to the ATIS 102. The data processing system 302 can be connected to the vehicle 101 and the TMS 400 via the network 301. The data processing system 302 can be connected to the network 301 via a wired or wireless connection.

Each of the one or more components of the data processing system 302 can be implemented using hardware or a combination of software and hardware. Each component of the data processing system 302 can include logical circuitry (e.g., a central processing unit or CPU) that responses to and processes one or more instructions fetched from a memory unit (e.g., memory, storage device, or remote data repository 312). Each component of the data processing system 302 can include or use a microprocessor or a multi-core processor. A multi-core processor can include two or more processing units on a single computing component. Each component of the data processing system 302 can be based on any of these processors, or any other processor capable of operating as described herein. Each processor can utilize instruction level parallelism, thread level parallelism, different levels of cache, etc. For example, the data processing system 302 can include a logic device such as a computing device or server having at least one processor.

The one or more components or elements of the data processing system 302 can be one or more separate components, a single component, or be part of the data processing system 302. For example, the model generator 306 (or the other components of the data processing system 302) can include one or more combinations of hardware and software, such as one or more processors configured to initiate model generation commands, initiate update model commands, and transmit or receive the model information. The one or more components can work individually external to the data processing system 302.

The one or more component of the data processing system 302 can be configured or updated by the administrator device 322. The one or more components of the data processing system 302 can be connected or communicatively coupled to one another. The connection between the various components of the data processing system 302 can be wired or wireless, or any combination thereof.

The interface 304 of the data processing system 302 can include one or more ports for connecting to the network 301 or the administrator device 322. The one or more ports can include, for example, a serial port, USB port, Ethernet port, or Bluetooth receiver and transmitter. The interface 304 can transmit or receive one or more remote data repository 312 information to or from the vehicle 101 or the administrator device 322. The information of the remote data repository 312 can include a heat map 314, a forecast technique 316, an inspection model 318, and historical data 320. The interface 304 of the data processing system 302 can be similar to the interface 106 of the ATIS 102. For example, the interface 304 can be provided with one or more inspection information by the vehicle 101 to store or update the historical data 320. The interface 304 can be provided with one or more previous inspection information from a plurality of tanks 202 inspection by the administrator device 322 to update the historical data 320.

The model generator 306 can generate a risk-based inspection model 318 based on a time-series of quality metrics 136 determined based on ultrasonic thickness data or the loops of electric current provided by the inspection device 122 that extend towards one or more portions of the tank 202. The inspection model 318 can be stored in the remote data repository 312. In some implementations, the quality metric 136 can only store one or more raw information of the tank 202 based on the information from the inspection device 122. The model generator 306 can access or utilize the historical data 320 of the tank 202, the historical data 320 comprising one or more information of the quality metrics 136 from one or more past inspection of various tanks 202. The model generator 306 can generate a model based on a forecast of the forecast engine 308 using the forecast technique 316. The forecast can provide an indication of predicted one or more level of thickness of the tank 202 based on one or more information of the historical data 320.

The model generator 306 can aggregate one or more historical quality metrics 136 from the historical data 320 obtained from a plurality of tank inspections to forecast a level of thickness of the tank 202 based on the quality metric 136. The historical quality metrics 136 indicating one or more thickness level of the tank 202. The forecast thickness level of the tank 202 can indicate the risk of leakage of the tank 202, the risk can be provided to the administrator device 322. For example, a plurality of quality metrics 136 of the tank 202 obtained from year 2018 can be aggregated with a quality metric 136 of the tank 202 obtained from year 2019 using the forecast engine 308. The forecast engine 308 can utilize the forecast technique 316 to indicate a deterioration rate of the tank 202, which can be based on the difference between the 2019 quality metric and the 2018 quality metric. The model generator 306 can receive the indication of the deterioration rate of the tank 202 and generate a risk-based inspection model 318 which can indicate a time leakage will occur in one or more portions of the tank 202.

Inputs to the risk-based inspection model 318 can include original design and construction drawings as well as information about the quality of the materials and fabrication techniques (e.g., welding or bolting) used to build the tank, which can provide a baseline for future inspections. A record of operating conditions can allow verification that the tank was operated within its functional limits (e.g., max fill level). A history of tank floor quality metrics, recorded during previous inspections, can be used as the primary driver to establish deterioration trends using a variety of models associated with different types of deteriorations (for instance general, local or pitting corrosion). The forecast engine 308 can perform risk analysis by determining the probability of failure, which is then converted into a period of time after which the tank should be taken out of service for repairs. The forecast engine 308 can assess the probability of failure based on a qualitative approach (engineering/expert judgement and experience using qualitative terms such as very unlikely, unlikely, possible, probable, or highly probable), a semi-qualitative approach (modification of the nominal floor failure frequency—if available—by factors specific to the particular floor's management and environment) or a quantitative approach (structural reliability analysis method). The output of the model can include a period of time the tank can remain in service until the tank should be taken out of service for repairs. Thus, the model generator 306 can generate a risk-based inspection model based on a time-series of quality metrics (e.g., determined based on the loops of electric current provided by the inspection device that extend towards the portion of the tank), and aggregate the historical quality metrics obtained from a plurality of tank inspections to forecast a level of thickness of the tank based on the quality metric.

The forecast engine 308 can access one or more forecast techniques 316 to perform a risk prediction of the tank 202. The risk can indicate a corrosion level of the tank 202, an indication of the tank 202 thickness over time, or a leakage time of the tank 202. The risk can be determined based on a historical quality metric 136, a historical flammable fluid level, or a historical environment of the tank 202. The historical quality metric 136 can indicate one or more thickness levels of the tank 202 from one or more past inspection. The historical flammable fluid level can indicate a plurality of periodic flammable fluid levels of the tank 202 based on flammable fluid level information provided by the administrator device 322, or the historical data 320 including flammable fluid level information from a previous inspection of the tank 202. The historical environment or an environmental information of the tank 202 can indicate a plurality of periodic information based on atmospheric information (e.g. gases and other atmospheric particles) or a climate information provided by the administrator device 322 or the historical data 320 comprising one or more environmental conditions (e.g. temperature, humidity, etc.) of the tank 202 based on one or more past inspection. The forecast engine 308 can generate a graph to indicate a corrosion rate based on one or more historical data 320 containing a plurality of quality metric 136 from a plurality of inspections, the graph can be a time to thickness comparison. The quality metric 136 from the historical data 320 can be one or more points on the graph, for example, the forecast engine 308 can use a first quality metric 136 from an inspection of the tank 202 performed in the year 2010 and a second quality metric 136 from an inspection performed in the year 2015 to generate a line on the graph illustrating a linear rate of decay of the tank 202. The forecast engine 308 can further use the plurality of quality metric 136, such as 50 quality metrics 136 over a time, to predict a time interval for leakage based on the condition of the tank 202. The condition of the tank 202 can include a geographical location of the tank 202, a fuel level contained in the tank 202, or a current thickness of the tank 202. In some implementations, the graph can display a linear decay rate based on the tank 202 thickness from 20 cm to 15 cm and an exponential decay rate based on the tank thickness from 15 cm to 0 cm.

The map generator 310 can generate a heat map 314 of the tank 202 based on the quality metric 136 of the one or more portions of the tank 202. The map generator 310 can initiate a generation of the heat map 314, based on the vehicle 101 providing the tank map 130 and the quality metric 136 to the data processing system 302 via the network 301. The map generator 310 can aggregate the tank map 130 information and the quality metric 136 information to generate a heat map 314 indicating one or more levels of thickness of a plurality of portions of the tank 202 using a plurality of color codes. The plurality of color codes can range from red to green to blue. For example, a very thick portion of the tank 202 can be color coded with blue, a very thin portion of the tank 202 can be color coded with red, and a spectrum of color between the blue and the red can indicate the gradual increase or decrease of the thickness of the one or more portions of the tank 202. The map generator 310 can generate a 2-D heat map 314 or a 3-D heat map 314 of the tank 202 indicating the thickness of the plurality of portions of the tank 202.

The remote data repository 312 can include the heat map 314, the forecast technique 316, the inspection model 318, or the historical data 320. The remote data repository 312 can include storage (e.g., hard disk drives, solid state drives, floppy disks, magnetic tape, etc.) which can store tank information including information associated with previous inspections of one or more tanks. The remote data repository 312 can store environmental information. The environmental information can include, for example, atmospheric information (e.g., pressure, gases, atmospheric particles), climate information (e.g., temperature, humidity, radiation, and amount of rain), topographic information, altitude information, ground information, or subsurface information. The data processing system 302 can obtain the environmental information from the vehicle 101. The data processing system 302 can obtain the environmental information from external sources or databases. The administrator device 322 can provide the environmental information to the data processing system 302.

The heat map 314 can include or store a plurality of color-coded tank maps 130 of the tank 202 generated by the map generator 310. The color code can range from red to green to blue. The heat map 314 can utilize the plurality of color codes to provide a graphical representation of the tank map 130 indicating the thickness level of the tank 202. For example, a very thick portion of the tank 202 can be color coded with blue, a very thin portion of the tank 202 can be color coded with red, and a spectrum of color between the blue and the red can indicate the gradual increase or decrease of the thickness of the one or more portions of the tank 202. The heat map 314 can indicate the texture of the tank 202 based on the thickness level information. The texture of the tank 202 can represent one or more bumps or one or more dips of the tank 202. The plurality of color code can be configured by the administrator device 322. The heat map 314 can be provided to the administrator device 322 to display the graphical representation of the tank map 130. The heat map 314 can store a 2-D heat map 314 or a 3-D heat map 314 of the tank 202 generated by the map generator 310.

The forecast technique 316 can include a plurality of time-series forecasting techniques for determining a risk-based inspection model 318. The forecast technique 316 can be accessed or used by the forecast engine 308. The risk can represent a deterioration rate of the tank 202 based on the difference between present and one or more past tank 202 thickness level, the environmental information, or the historical data 320. The risk can further represent a predicted leakage time of the one or more portions of the tank 202 or the indication of one or more thickness level of the tank 202 over time. The predicted time of leakage can be based on the present thickness level of the one or more portions of the tank 202 and the corrosion rate of the tank 202. The forecast technique 316 can be assisted by a machine learning technique or one or more information from the administrator device 322.

The inspection model 318 can store a plurality of risk-based model based on the time-series of quality metrics 136 generated by the model generator 306. The inspection model 318 can be a human readable report. The inspection model 318 can be provided to the administrator device 322 indicating the corrosion rate of the tank 202, at least an indication of the tank 202 thickness over time, or the predicted time of leakage of the tank 202. The inspection model 318 can be presented in a graphical format or a table. For example, the inspection model 318 can be generated and stored in the remote data repository 312 by the model generator 306. The inspection model 318 can be accessed and obtained by the administrator device 322 to display an inspection model 318, which can include the indication of the corrosion rate, the thickness over time, or the predicted time of leakage of the tank 202. The inspection model 318 can be used by the administrator device 322 to identify a maintenance time for one or more portions of the tank 202, at least an inspection cycle for the tank 202, or at least an indication of occurring leakage of the tank 202. The occurring leakage of the tank 202 can be based on an absence of one or more portions of the tank 202 identified by the inspection device 122.

The historical data 320 can include or store one or more quality metrics 136 which can indicate the thickness level of the tank 202. The historical data 320 can include or store a plurality of quality metrics 136 from one or more previous inspections of a plurality of tanks 202. Each tank 202 of the plurality of tanks 202 can be different in at least dimension, construction, or location. The historical data 320 can include or store a flammable fluid level of the tank 202, dimensions of tank 202, or the environmental information of the tank 202. The environmental information can include atmospheric information (e.g., gases and other atmospheric particles) or an environmental condition (e.g., temperature, humidity, pressure, or altitude) of the tank 202. The historical data 320 can be obtained, configured, or updated by the administrator device 322. The historical data 320 can be accessed by the forecast engine 308 or the model generator 306 for generating an inspection model 318. The vehicle 101 can receive historical data 320 via a network.

The administrator device 322 can include an interface 304 similar to the data processing system 302 or the ATIS 102. The interface can include an LCD display, serial port, USB port, display port, Ethernet port, or Bluetooth receiver and transmitter. The administrator device 322 can be connected to the data processing system 302 via wired or wireless connection to the interface 304 of the data processing system 302. The administrator device 322 can be remote to the data processing system 302. The administrator device 322 can configure or update one or more components of the data processing system 302 which can include the model generator 306, the forecast engine 308, the map generator 310, or the remote data repository 312.

The administrator can be provided with a risk-based inspection model 318 based on a time-series of quality metrics 136, the inspection model 318 can be displayed on the administrator device 322 illustrating one or more risk of the tank 202 including the corrosion rate of the tank 202, at least an indication of the tank 202 thickness over time, or the predicted time of leakage of the tank 202. The administrator device 322 can update the historical data 320 with one or more quality metrics 136 of a plurality of tanks 202 via the interface 304. The administrator device 322 can update the historical data 320 with one or more environmental information of the tank 202. The administrator device 322 can provide one or more settings to adjust one or more color codes of the heat map 314 or adjust a type of heat map 314 to generate (e.g., 2-D or 3-D). The administrator device 322 can update the forecast technique 316 based receiving a different technique for forecasting. The administrator device 322 can identify a maintenance time for one or more portions of the tank 202, an inspection cycle for the tank 202, or an indication of occurring leakage of the tank 202 based on the inspection model 318.

The systems described above can provide multiple ones of any or each of those components and these components can be provided on either a standalone system or on multiple instantiations in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence has any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. Scope of the systems and methods described herein is thus indicated by the appended claims, rather than the foregoing description, and changes that come within the meaning and range of equivalency of the claims are embraced therein.

What is claimed is:

1. A system for a tank inspection vehicle configured to operate in a tank containing a flammable fluid, the system comprising:
a tether configured to provide power to the tank inspection vehicle;
a cable configured to provide power across a vapor layer of the flammable fluid in the tank;
a tether management system comprising:
a reel configured to control a length of the tether coupled thereto;
a control unit configured to operate the reel such that a target length of the tether extends between the tether management system and the tank inspection vehicle, the target length based on a position of the tank inspection vehicle relative to the tether management system when deployed in the tank; and
a float switch electrically coupling the tether to the cable by closing a circuit therebetween when a buoyant force on the float switch is greater than a force threshold, and configured to electrically disconnect the tether from the cable by opening the circuit when the buoyant force on the float switch is less than the force threshold.

2. The system of claim 1, wherein the float switch is configured to electrically couple the tether to the cable in response to an entirety of the length of the tether being submerged beneath a surface of the flammable fluid.

3. The system of claim 1, wherein:
the tether is negatively buoyant relative to the flammable fluid, the tether having a first end coupled to the tank inspection vehicle and a second end coupled to the switch such that a length of the tether extends between the first end and the second end, and the target length extends between the first end and the reel; and
the cable is a C1D1 power and communications cable having a first end coupled to the switch and a second end coupled to a power source disposed outside of the tank.

4. The system of claim 3, wherein the tether management system is configured to sink entirely beneath a surface of the flammable fluid when deployed inside the flammable fluid of the tank.

5. The system of claim 3, wherein the tether management system further comprises a float such that a first portion of the tether management system is configured to remain above a surface of the flammable fluid and a second portion of the tether management system is configured to remain below the surface of the flammable fluid when deployed inside the flammable fluid of the tank.

6. The system of claim 1, further comprising:
a cover surrounding at least a portion of the cable; and
a source coupled to the cover and configured to pressurize a space between the cover and the cable with an inert gas.

7. The system of claim 1, wherein the tether management system further comprises a frame coated with a non-flammable solution or an insulator.

8. A system for inspecting a tank containing a flammable fluid, the system comprising:
a power source disposed outside the tank;
a float configured coupled to a tether management system such that a first portion of the tether management system is configured to remain above a surface of the flammable fluid and a second portion of the tether management system is configured to remain below the surface of the flammable fluid when deployed inside the flammable fluid of the tank;
a cover coupled to the tank and having an adjustable cable passageway extending therethrough;
a cable coupled to the power source, extending through the adjustable cable passageway, and coupled to a switch of a tether management system, the cable secured in the adjustable cable passageway such that the tether management system remains positioned substantially beneath a roof manway of the tank at a first position;
a tether coupled to the switch of the tether management system and to a tank inspection vehicle, the tether configured to provide power to the tank inspection vehicle when the tether is fully submerged in the flammable fluid; and
a control unit configured to operate a reel to control a target length of the tether extending between the tether management system and the tank inspection vehicle, the target length configured to increase or decrease corresponding to a change in a distance between the tank inspection vehicle and the first position of the tether management system.

9. The system of claim 8, wherein the switch is configured to electrically couple the tether and the cable in response to at least a portion of the tether management system being lowered into the flammable fluid and a float of the switch being urged toward a surface of the flammable fluid to actuate the switch.

10. The system of claim 8, further comprising a float coupled to the tether proximate to the tank inspection vehicle, the float configured to urge the tether away from a propeller of the tank inspection vehicle.

11. The system of claim 8, wherein the cable is secured in the adjustable cable passageway such that flammable vapors are substantially prevented from passing therethrough.

12. The system of claim 8, further comprising a motor configured to operate the reel of the tether management system, the motor receiving power and communications signals in response to being completely submerged in the flammable fluid.

13. The system of claim 8, further comprising a sensor coupled to the tether management system configured to send data indicative of a position of the tether management system within the tank to the control unit.

14. The system of claim 13, wherein the sensor comprises at least one of an optical sensor or an ultrasonic sensor.

15. A method for managing a tether of a tank inspection vehicle, the method comprising:
submerging the tank inspection vehicle in a flammable fluid of a tank;
at least partially submerging a tether management system in the flammable fluid of the tank, the tether management system comprising:
a cable configured to provide power across a vapor layer of the flammable fluid in the tank;
the tether coupling the tank inspection vehicle to a reel of the tether management system, the tether configured to provide power and communications signals to the tank inspection vehicle;
a switch configured to electrically couple the tether to the cable;
a control unit configured to operate the reel to control a target length of the tether extending between the tether management system and the tank inspection vehicle;
after an entirety of the tether is submerged beneath the flammable fluid, actuating the switch to provide power and communications signals to the tank inspection vehicle via the tether;
during an operation of the tank inspection vehicle, determining, by the control unit, the target length based on a position of the tether management system within the tank and a position of the vehicle such that the target length does not exceed a maximum length based on a size of the tank; and
operating the reel by the control unit such that the target length extends between the tether management system and the tank inspection vehicle.

16. The method of claim 15, further comprising:
in response to a distance between the tether and a surface of the flammable fluid falling below a minimum distance, actuating the switch to disconnect the tether from a power source.

17. The method of claim 15, further comprising:
sealing a manway of the tank with a cover including a sealable cable passageway; and
disposing the cable through the sealable cable passageway to form a vapor-tight seal across the manway.

18. The method of claim 15, further comprising:
receiving, via a user interface of the control unit, a command to increase or decrease the target length of the tether extending between the tether management system and the tank inspection vehicle.

19. The method of claim 15, further comprising:
receiving, by the control unit, a position of the tank inspection vehicle;
receiving, by the control unit, a position of the tether management system; and
determining, by the control unit and based on the position of the tank inspection vehicle and the position of the tether management system, the target length of the tether.

20. The method of claim 15, further comprising:
reporting to a user interface, by the control unit, at least one of:
a distance between the tank inspection vehicle and a manway of the tank, or
a distance between the tether management system and the manway of the tank.
